(19) United States
(12) Patent Application Publication
(10) Pub. No.: US 2026/0156517 A1
(43) Pub. Date: Jun. 4, 2026

(54) INFORMATION PROCESSING METHOD, INFORMATION PROCESSING APPARATUS, AND INFORMATION PROCESSING SYSTEM

(71) Applicant: SONY GROUP CORPORATION, TOKYO (JP)

(72) Inventors: HIROAKI TAKANO, TOKYO (JP); HIROTO KURIKI, TOKYO (JP); HIROFUMI KASAI, TOKYO (JP); TOMOAKI MATSUMURA, TOKYO (JP)

(21) Appl. No.: 18/706,769

(22) PCT Filed: Oct. 26, 2022
(86) PCT No.: PCT/JP2022/039918

§ 371 Date: May 2, 2024

(30) Foreign Application Priority Data
Nov. 10, 2021 (JP) 2021-183289

(51) Int. Cl. H04W 28/02; H04W 28/08; H04W 28/24

(52) U.S. Cl. CPC H04W 28/0268; H04W 28/0975; H04W 28/0983; H04W 28/24

(57) ABSTRACT

An information processing method is executed by an information processing apparatus that manages communication using a predetermined network slice of a non-public cellular closed network. A guarantee of low latency is notified to a device that manages a first user plane function (UPF) or a node that uses the first UPF. The first UPF is a UPF resource of the predetermined network slice.

### FIELD

The present disclosure relates to an information processing method, an information processing apparatus, and an information processing system.

### BACKGROUND

In recent years, a private network using cellular wireless communication has been attracting attention. As a use case of the private network, remote control of equipment, a game, and the like are known.

### CITATION LIST

### Patent Literature

Patent Literature 1:2021-013183 A

### SUMMARY

### Technical Problem

For example, in order to improve a response to an operation such as remote control or a game, it is important to maintain a low-latency communication quality. However, in the conventional technology, there is a case where a sufficiently low-latency communication quality using the private network cannot be maintained.

Therefore, the present disclosure proposes an information processing method, an information processing apparatus, and an information processing system capable of maintaining a sufficient low-latency communication quality of communication using the private network.

Note that the above problem or object is merely one of a plurality of problems or objects that can be solved or achieved by a plurality of embodiments disclosed in the present specification.

### Solution to Problem

In order to solve the above problem, an information processing method according to one embodiment of the present disclosure executed by an information processing apparatus configured to manage communication using a predetermined network slice of a non-public cellular closed network, the method includes: giving a notification regarding a guarantee of low latency to a device that manages a first user plane function (UPF) or a node that uses the first UPF, the first UPF being a UPF resource of the predetermined network slice.

### BRIEF DESCRIPTION OF DRAWINGS

FIG. 1 is a diagram illustrating an example of a private network.

FIG. 2 is a diagram illustrating a communication system in a case where a destination is one 4G/5G private network.

FIG. 3 is a diagram illustrating a communication system in a case where a destination is a plurality of 4G/5G private networks.

FIG. 4 is a diagram illustrating a frame configuration of 5G.

FIG. 5 is a diagram illustrating QoS control.

FIG. 6 is a diagram illustrating a network slice.

FIG. 7 is a diagram illustrating an experimental result of a delay property of each network slice.

FIG. 8 is a diagram illustrating a difference in a delay property of a network slice due to a difference in a packet size.

FIG. 9 is a diagram illustrating a configuration example of a communication system according to an embodiment of the present disclosure.

FIG. 10 is a diagram illustrating a configuration example of a management device according to the embodiment of the present disclosure.

FIG. 11 is a diagram illustrating a configuration example of a base station according to the embodiment of the present disclosure.

FIG. 12 is a diagram illustrating a configuration example of a terminal device according to the embodiment of the present disclosure.

FIG. 13 is a diagram illustrating a configuration example of a network management device according to an embodiment of the present disclosure.

FIG. 14 is a diagram illustrating an example of a 5G architecture.

FIG. 15 is a diagram illustrating an example of a 4G architecture.

FIG. 16 is a sequence diagram illustrating a procedure of using a network slice for low latency.

FIG. 17 is a diagram illustrating a method of measuring a delay time of a packet passing through a UPF1 or a base station.

FIG. 18 is a sequence diagram illustrating a procedure of using the network slice for low latency.

FIG. 19 is a diagram illustrating a static/semi-static scheduling method.

FIG. 20 is a sequence diagram illustrating a procedure of semi-static application level scheduling.

FIG. 21 is a diagram illustrating a dynamic scheduling method.

FIG. 22 is a sequence diagram illustrating a procedure of dynamic application level scheduling.

FIG. 23 is a conceptual diagram of a time direction of dynamic scheduling in a plurality of private networks.

FIG. 24 is a sequence diagram illustrating the procedure of dynamic application level scheduling.

### DESCRIPTION OF EMBODIMENTS

Hereinafter, embodiments of the present disclosure will be described with reference to the drawings. In each of the following embodiments, same parts are given the same reference signs to omit redundant description.

In addition, in the present specification and the drawings, a plurality of components having substantially the same functional configuration may be distinguished by attaching different numerals after the same reference sign. For example, a plurality of configurations having substantially the same functional configuration is distinguished as terminal devices 301, 302, and 303 as necessary. However, when it is not particularly necessary to distinguish each of the plurality of components having substantially the same functional configuration, only the same reference sign is given. For example, in a case where it is not necessary to particularly distinguish the terminal devices 301, 302, and 303, they are simply referred to as terminal devices 30.

In the description below, one or more embodiments (including examples and modifications) can be implemented independently. On the other hand, at least some of the plurality of embodiments described below may be appropriately combined with at least some of other embodiments. The plurality of embodiments may include novel features different from each other. Therefore, the plurality of embodiments can contribute to solving different objects or problems, and can exhibit different effects.

Note that the description will be given in the following order.

The present disclosure will be described according to the following item order.
1. Outline
1-1. Local 5G/Private 5G
1-2. Features of private network
1-3. Cooperation of a plurality of private networks
1-4. Outline of problems and solutions of present
embodiment
2. Configuration of communication system
2-1. Configuration example of communication system
2-2. Configuration of management device
2-3. Configuration example of base station
2-4. Configuration example of terminal device
2-5. Configuration example of network management device
3. Network architecture
3-1. Configuration example of 5G network architecture
3-2. Configuration example of 4G network architecture
4. First Embodiment
4-1. Problem
4-2. Solution 1
4-3. Solution 2
5. Second Embodiment
5-1. Problem
5-2. Solution 1
5-3. Solution 2
5-4. Solution 3
5-5. Solution 4
6. Modification
7. Conclusion

### 1. Outline

In recent years, private networks such as a local 5G and a private 5G have been attracting attention. The private network is also referred to as a non-public network.

### <1-1. Local 5G/Private 5G>

The local 5G and the private 5G are cellular communication services performed in a limited area such as a factory, an office, a studio, a hospital, and a university. By providing the service in a limited local area, there is an advantage that a customized cellular service can be provided. In the present embodiment, the private 5G and the local 5G may be referred to as a 4G/5G private network or a 4G/5G virtual private network. Note that the private network is not limited to the 4G/5G private network. In the following description, the private network may be referred to as a non-public cellular closed network or simply a closed network.

Security is given importance in many use cases. For example, in the case of a factory, a factory production line handles technology with high confidentiality. Also in a hospital, for example, personal information regarding privacy of a patient is often handled, and thus, this is a use case with high confidentiality. Also in universities and offices, personal information is often handled, and communication related to the personal information requires high confidentiality.

### <1-2. Features of Private Network>

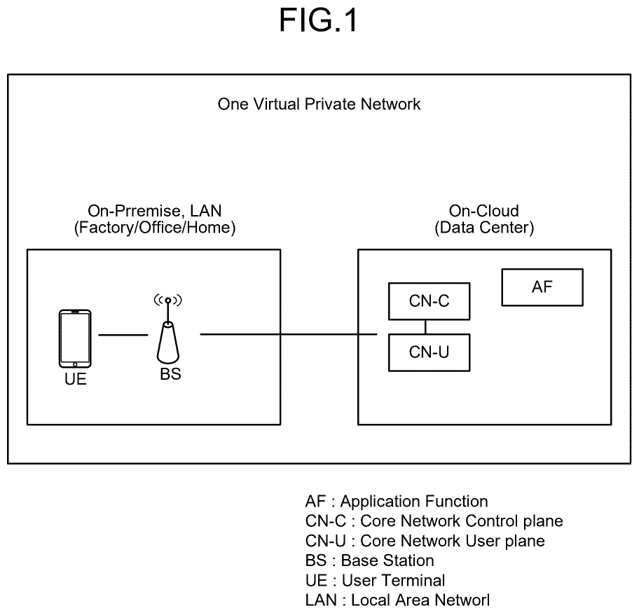

Before describing an overview of the present embodiment, features of the private network will be described. FIG. 1 is a diagram illustrating an example of the private network.

### (1) Properties of Closed Network

In the private network, a LAN and a cloud are connected in a closed network. The closed network is, for example, a virtual private network (VPN). In the closed network, a base station disposed in the LAN and a core network disposed in the cloud are connected using a private IP address without using a public IP address. When communication is performed only in the closed network, the network is resistant to eavesdropping from outside and the like. In addition, setting to completely block access from the outside of the closed network is possible. Still more, it is possible to send a packet from inside to outside the closed network and only allow a response to enter the closed network. In general, it is not possible to access a device or a terminal device in the closed network by applying a trigger from outside the closed network. Thus, it can be said that the confidentiality of the closed network is high.

Since conversion between a private IP address and a global IP address is not required, user datagram protocol (UDP) communication can be easily used. When conversion is required, a transmission control protocol (TCP) is usually used. Therefore, a feature that UDP communication is easy to use is attractive for an application using UDP communication. The use of UDP has an advantage that a delay is small.

### (2) IP Address Assigned to Terminal Device

When the terminal device accesses the network, an IP address is assigned from the core network to the terminal device. Usually, a private IP address is assigned. In the case of a public network, a public IP address may be directly assigned to the terminal device, but in a 4G/5G private network that is a non public network, the private IP address is usually assigned to the terminal device. Therefore, when going out from the closed network, the private IP address is converted into the public IP address by network address translation (NAT).

It is possible to acquire the information on the IP address assigned to the terminal device from the core network. In the 5G, an application program interface (API) called a service based interface (SBI) is provided to acquire the IP address of the terminal device. Even in the 4G, the IP address of the terminal device can be acquired similarly to the 5G by accessing a subscriber file storing the IP address of each terminal device.

In the closed network, by holding the IP address of the terminal device, it is possible to directly transmit an IP packet to the terminal device from an application function (AF) side (i.e., network initiated message push).

### <1-3. Cooperation of a Plurality of Private Networks>

In the present embodiment, communication between different private networks is considered. For example, a case of connecting a plurality of 4G/5G private networks over the Internet will be considered. In this case, since a packet is once sent to the public Internet, a security threat increases. It is not desirable, from the security perspective, to directly transmit the IP address of the terminal device to a destination. In addition, since the private IP address is converted into the public IP address once when using the Internet, a problem of network address translation (NAT) traversal occurs. Therefore, direct UDP communication is difficult.

Note that, in a normal cellular system, when a packet is transmitted from outside a cellular network to a terminal device by specifying the IP address, the packet may or may not arrive directly. Although it is limited to a case where a telecommunications carrier has abundant global IP addresses, when a global IP address is directly assigned to the terminal device, it is possible to directly send a packet from outside to the global IP address. However, it can be said that this depends on a security policy. When a packet can be directly sent, there is a risk that undesired traffic flows in from the outside, and therefore such a packet is not allowed in most cases. In other words, since the security threat is large, a degree of freedom may be reduced when a security measure is taken. It is not desirable, from the security perspective, to directly transmit the IP address of the terminal device to a destination. In the case of a cellular system, there is also a problem that cost of the cellular network is higher than that of the 4G/5G private network. Therefore, it will be important in the future to prepare a plurality of 4G/5G private networks and directly connect the 4G/5G private networks by a VPN tunnel.

Therefore, hereinafter, a case where different private networks are connected by the VPN tunnel will be considered.

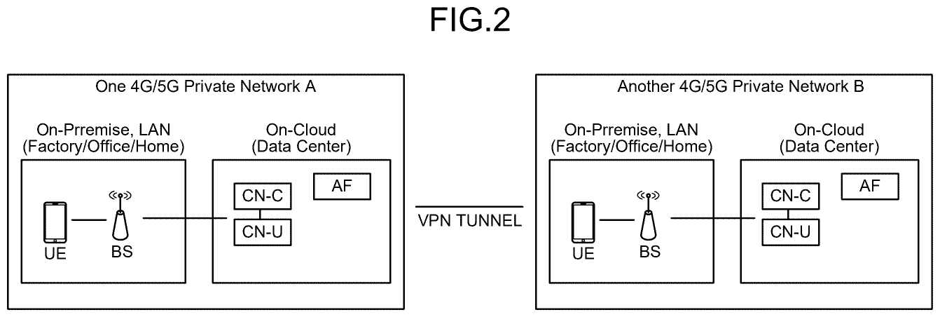

FIG. 2 is a diagram illustrating a communication system when the destination is one 4G/5G private network. In an example in FIG. 2, two 4G/5G private networks are directly connected by VPN tunneling. Since closed networks are connected to each other, the packet can be transmitted to the terminal device or a client application of the destination using the private IP address in the closed networks.

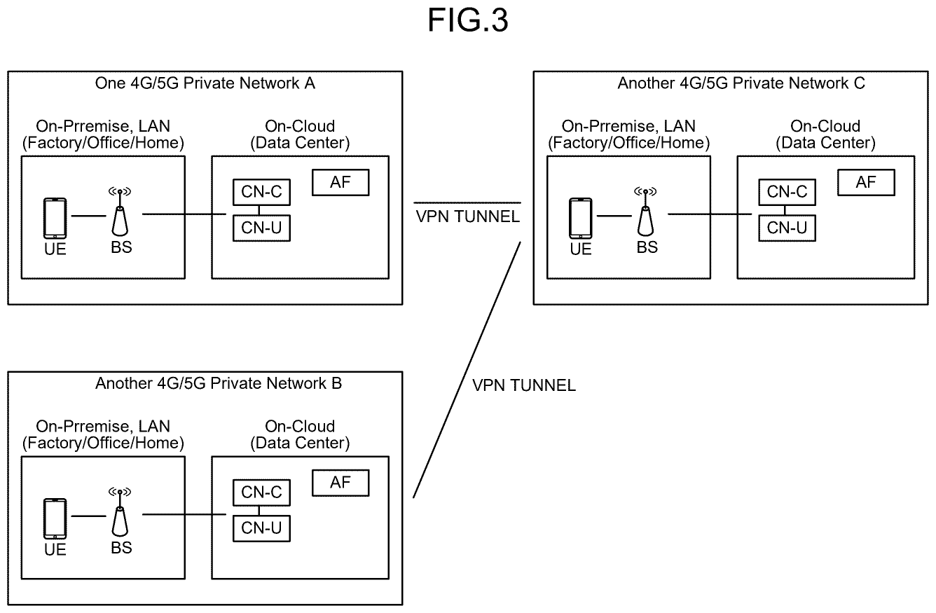

FIG. 3 is a diagram illustrating a communication system when the destination is a plurality of 4G/5G private networks. When there are a plurality of destinations, as illustrated in FIG. 3, the VPN tunnel is set with each of the plurality of destinations. A star connection is not desirable because there is a large influence when a failure occurs in a central switch. In the case of 1:1 pairing, since information is spread only to the destination, this topology is desirable also from the security perspective.

Note that a method of connecting the plurality of 4G/5G private networks by secure communication is not limited to a method using the virtual private network (VPN) tunnel. As a method of connecting the plurality of 4G/5G private networks by secure communication, for example, a method of connection by a dedicated line is conceived.

Here, a use case of a network in which the plurality of 4G/5G private networks cooperate is considered. The following is conceived as the use case.

### (1) Internet of Things (IoT)

There is a request to arrange IoT devices under the 4G/5G private network, control the IoT devices by an information processing apparatus, and extract information from the IoT devices. In this case, when the IoT devices in only one 4G/5G private network are controlled to acquire information, there is a problem of an insufficient scale of the IoT system since the number of IoT sensors is limited. Therefore, there is a demand for collecting the information by cooperation of the plurality of private networks. In this case, a location of the IoT device to communicate with is often known in advance. Since TCP connection tends to impose a heavy load of power consumption on the IoT device, there is a demand for communication using UDP.

### (2) Game

When playing a network game, it may be conceived that another player belongs to a different 4G/5G private network. In this case, since a player with which communication is desired is the player determined by a server of the game, it is often not known who to communicate with until immediately before. In this case, communication by UDP rather than TCP is often demanded due to delay constraints.

### (3) Remote Monitoring

One may wish to monitor a video from a remote camera. In the case of a video such as VR, a large capacity and a low latency may be required. It is desirable, from the security perspective, that communication can be performed between 4G/5G private networks when a monitoring video is very important information.

### (4) Others

A plurality of private networks may belong to different operators. It is desirable that one operator performs network management of the plurality of private networks, but customers using the private networks are different. For example, it is assumed that there are a customer A who measures wind power in Japan using an IoT sensor and a customer B who measures wind power in Europe using an IoT sensor. Then, it is assumed that a terminal device of the customer A is connected to a private network A, and a terminal device of the customer B is connected to a private network B. At this time, it is assumed that an operator C needs to collect information from the terminal devices of the customers A and B using a terminal device connected to a private network C. In this case, it is considered that the operator C desires to connect the private networks A and B.

### <1-4. Outline of Problems and Solutions of Present Embodiment>

Based on the above, an outline of problems and solutions of the present embodiment will be described.

It is very important to keep a low-latency communication quality. This is because low latency is important for improving a response to a remote control or the operation of a game or the like. Here, it is more important to improve a delay in a poor network condition than to improve a delay in a best network condition. There are various improvement methods.

### <1-4-1. Method of Shortening Processing Frame>

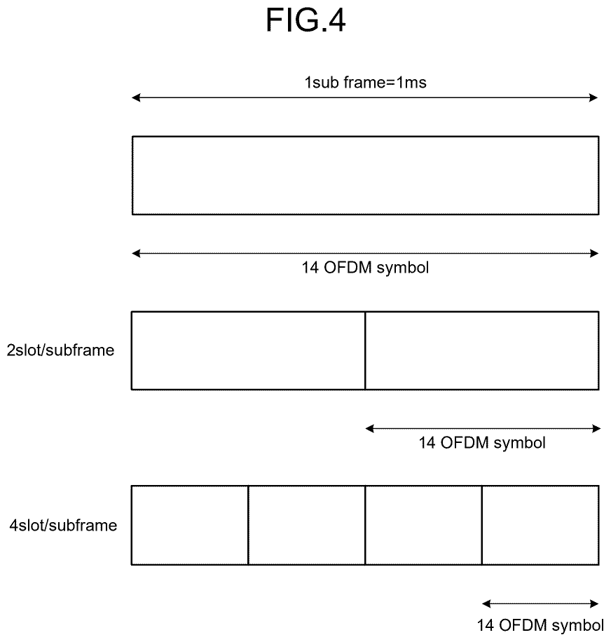

In general, it is known that the use of 5G is better than 4G in order to realize low latency. A reason that a delay of 5G is lower than a delay of 4G is that a unit of data handled is basically smaller. FIG. 4 is a diagram illustrating a 5G frame configuration. As illustrated in FIG. 4, in 5G, many slots can be provided in a subframe of 1 ms. By providing many slots in an 11-ms subframe, time required for a processing unit is shortened. As a result, 5G realizes low latency.

This method can be basically considered as a method of reducing the delay in the best network condition. Since the processing unit is small, there is an effect of reducing a delay particularly when retransmission occurs. However, a processing delay is increased at the moment retransmission occurs. This method exhibits the highest performance only when there is little traffic, good radio quality, and no occurrence of retransmission.

### <1-4-2. Method of Increasing ARQ Process>

When a radio section is included in a communication path, a reception error may occur on a reception side due to deterioration in communication quality. In this case, a communication apparatus on the reception side requests a communication apparatus on a transmission side to transmit a packet of the same content (or complementing content) again, and the communication apparatus on the transmission side receives the request and transmits the packet again. Note that there is a problem that the communication apparatus cannot transmit other packets while this retransmission process is being executed. In order to solve this problem, a plurality of automatic repeat request (ARQ) processes may be provided to simultaneously operate a plurality of retransmission processes, priority control may be used for preferentially transmitting a low-latency packet than the retransmission process, or these methods may be used in combination. It can be said that, rather than maintaining the low-latency communication quality, these methods reduce an influence on low-latency communication when the communication quality is poor.

### <1-4-3. Method of Performing QoS Control>

When the number of packets using the communication path increases, a packet process timing is temporarily suspended frequently. In many cases, the delay increases at this timing. As an example of the timing at which the packet process is temporarily suspended, there is a timing at which hybrid ARQ (HARQ) is executed. When retransmission of the packet is repeated in HARQ, the packet may be stagnated in the base station. Also in a user plane function (UPF) of the core network, packets coming from the Internet side are once accumulated in a buffer. Therefore, when more packets than can be processed by the base station arrive at the core network, the number of packets accumulated in the buffer of the UPF increases. As a result, the delay increases. The delay always occurs by being queued in the buffer. This is the same for both uplink and downlink.

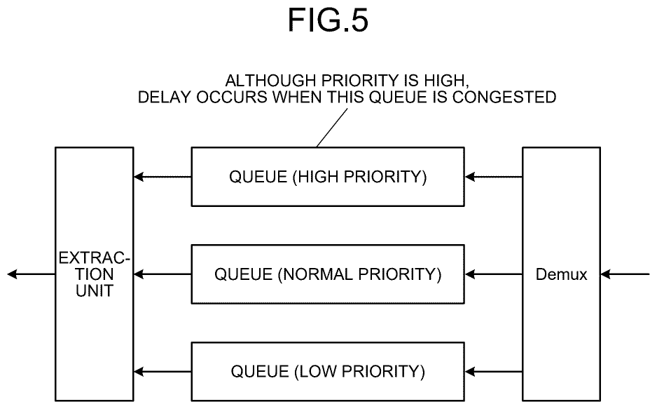

As a method of solving this problem, a quality of service (QoS) control has been generally used since the age of 4G. The QoS control is a method of assigning superiority and inferiority between traffics, making a low-priority traffic wait, and transmitting a high-priority traffic first. In a cellular system, a buffer or a scheduler with this QoS priority control can be arranged in the user plane function (UPF) or the base station, and in some cases, in an uplink of user equipment (UE). FIG. 5 is a diagram illustrating the QoS control. In an example in FIG. 5, Demux allocates data to one of a plurality of queues according to the priority of each piece of data. Then, an extraction unit extracts data from the queue according to the priority. Note that the queue illustrated in FIG. 5 has the same meaning as the buffer.

A traffic having QoS with high priority increases by an increase in load, congestion, or an increase in traffic volume. When queues with high priority are congested, an increase in delay cannot be avoided even though the QoS control is used.

### <1-4-4. Method of Using Network Slice>

Even when the QoS control is used to achieve low latency, the low latency cannot be guaranteed due to an increase in traffic with high priority QoS. When the queue with high priority is congested, the delay increases even though the priority control is performed. Therefore, it is important to prevent packets from being accumulated in the queue with high priority.

There is a technique for securing low latency by providing a network slice for low latency to avoid congestion. The network slice is a technology for securing individual frequency resources and user plane function (UPF) resources. The network slice is isolated from other network slices. Therefore, even when another network slice is congested, the network slice operating at a low load is not affected by the congestion.

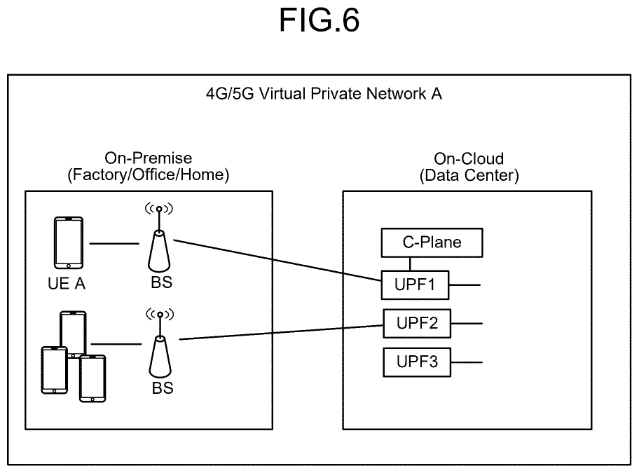

FIG. 6 is a diagram illustrating the network slice. In an example in FIG. 6, three UPFs, UPF1 to UPF3, are prepared. Each of the UPF1 to UPF3 constitutes a part of the network slice. In the following description, a network slice having the UPF1 as a UPF resource is referred to as a network slice 1, a network slice having the UPF2 as the UPF resource is referred to as a network slice 2, and a network slice having the UPF3 as the UPF resource is referred to as a network slice 3.

Referring to FIG. 6, in the network slice 1, only one UE uses a dedicated frequency resource and the UPF1. Therefore, there is a high possibility that the network slice 1 is operated with a low load. On the other hand, in the network slice 2, a plurality of UEs use a dedicated frequency resource and the UPF2. Therefore, there is a high possibility that the network slice 2 is operated with a high load.

In the example in FIG. 6, the base station is allocated to each network slice as the frequency resource, but a frequency domain (component carrier (CC)) that can be used by the base station may be allocated to each network slice. In addition, a band width part (BWP), which is an individual frequency domain in a component carrier, may be allocated to each network slice as the frequency resource.

Whether the scheduler with the QoS priority control of the base station is prepared for each network slice depends on implementation, but it is ideal that the scheduler is prepared for each network slice. In that case, since a traffic volume is kept low in a network slice for low latency, the traffic volume flowing into a corresponding scheduler with the QoS priority control is kept small.

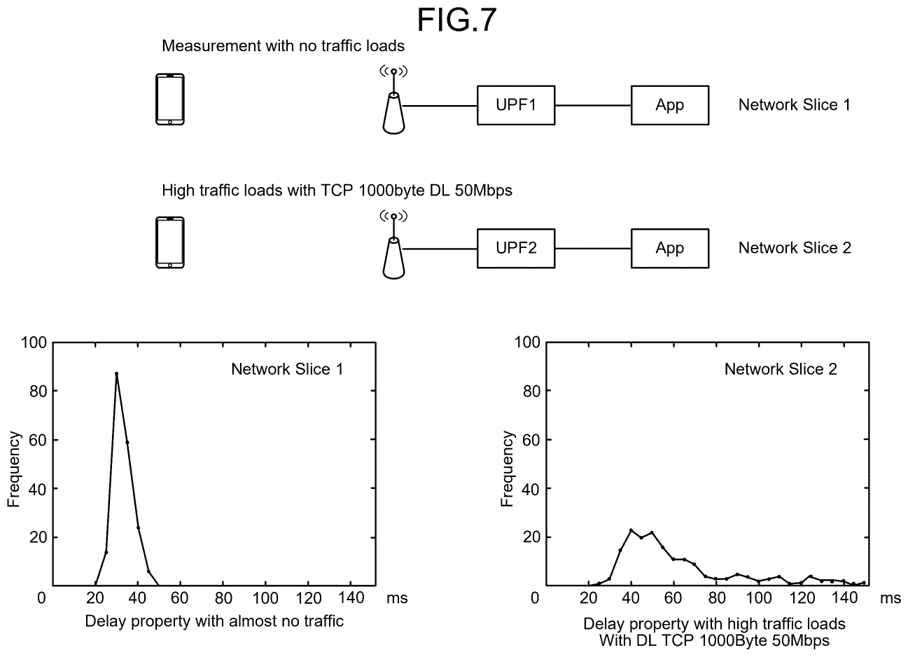

FIG. 7 is a diagram illustrating an experimental result of a delay property of each network slice. More specifically, FIG. 7 is a diagram illustrating a measurement result of the delay property of each network slice when the network slice 1 is always set to a low load (no traffic) and the network slice 2 is set to a high load (TCP 1000 byte DL 50 Mbps). In an example in FIG. 7, it can be seen that the network slice 1 maintains better delay property even when the network slice 2 has a high load.

However, even when the network slice is used, how to keep the state of the network slice low is still a problem. In addition, it is also a problem how to keep the state of the network slice in a low load when a plurality of private networks is connected.

### <1-4-5. Index for Maintaining Low Load>

Basically, a throughput is used as a means of delay evaluation. The throughput is an amount of data flowing through a certain function in one second. Furthermore, it is also possible to evaluate the delay of the network slice by measuring a delay of a certain section. The delay evaluation enables the information processing apparatus to evaluate whether it is still possible to add a load to the network slice. However, since this method measures delays at a plurality of points, there is a disadvantage that it takes time and effort to collect measurement results.

Here, it is necessary to consider whether the load applied to the network slice is evaluated by the throughput or actual delay measurement. For example, even with the same throughput, it is assumed that a packet length may affect the load.

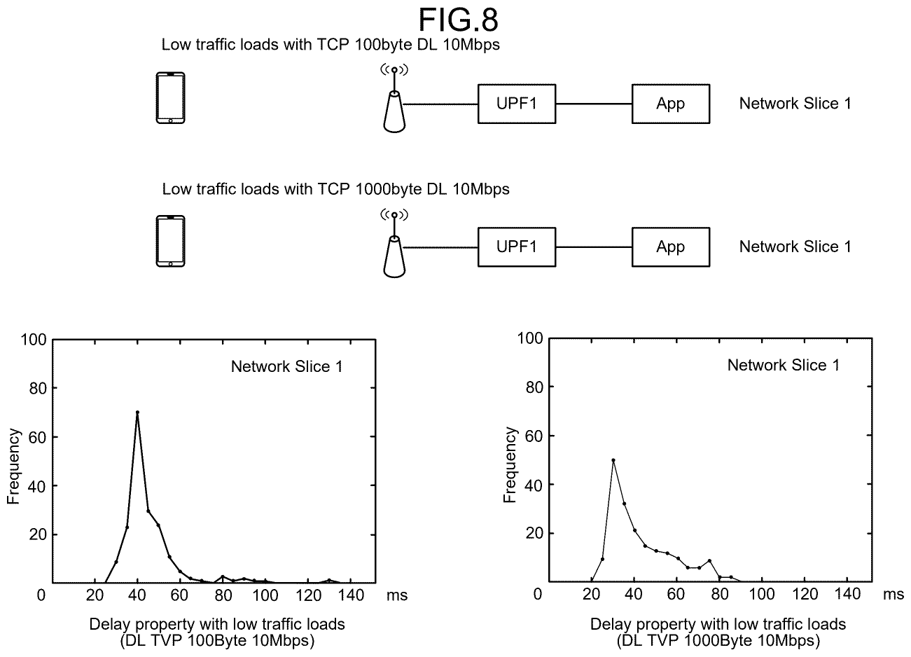

FIG. 8 is a diagram illustrating a difference in the delay property of the network slice by difference in a packet size. Both of two delay property graphs illustrated in FIG. 8 indicate measurement results of the delay property in the network slice 1. Both graphs are measurement results at a load of about 10 Mbps that is a low load, but one is a measurement result at a packet length of 100 bytes and the other is a measurement result at a packet size of 1000 bytes. It is apparent from FIG. 8 that the delay property changes by changing a packet length. When the packet size increases, a burst property of an interfering traffic increases, and thus the delay property deteriorates.

### <1-4-6. Limit of Method of Stochastically Keeping Low Load>

A throughput is one method of measuring the load of the network slice. The throughput is an amount of data processed on the network slice (or passed through the network slice) in one second. Note that the throughput merely indicates an amount of data that stochastically flows on an average of one second. Therefore, at a certain moment, data may continue to occupy the communication path. In the meantime, an important packet may be queued, resulting in a delay. In other words, keeping a low throughput merely indicates that the probability of achieving the low latency increases, and does not mean that a deterministic low latency (i.e., low latency with extremely high accuracy) can be achieved.

This limit is assumed to occur because the QoS control is performed only on the communication side, and an application layer generates traffic regardless of the communication side. In particular, the QoS control may function for adjustment of different QoS levels, but is not suitable for adjustment of the same QoS level.

Table 1 summarizes a case where the QoS control functions and a case where the QoS control does not function.

TABLE 1
Case where QoS control functions

| | Between different QoS | Between same QoS |
|---|---|---|
| Low load | Stochastically | No QoS control but QoS quality |
| | functioning | is stochastically secured in low |
| | | load |
| High load | Not functioning | QoS control is not functioning. |
| (Traffic with | | QoS quality deteriorates due to |
| high priority is | | high load |
| also high load) | | |

In Table 1, between the same QoS indicates, for example, a case where the QoS control is performed in one network slice when the same QoS is allocated to the one network slice. The network slice may be used to keep low load. In summary, even when the network slice is used to avoid that the QoS control does not function between traffic with different QoS levels at the time of high load, traffic with the same QoS gathers in one network slice. Therefore, the low latency can be stochastically secured, but a deterministic low latency cannot be guaranteed (i.e., guarantee of low latency with extremely high accuracy). This is summarized in Table 2 for ease of understanding.

TABLE 2
Case of same QoS in one network slice

| | Low load | High load |
|---|---|---|
| Stochastic low latency | ◯ | X |
| Deterministic low latency | X | X |

In other words, even when the network slice is used, low latency is achieved stochastically only when a low load is maintained.

### <1-4-7. When Connecting a Plurality of Private Networks>

In the case of connecting a plurality of private networks, a system for guaranteeing low latency by end to end (E2E) is required. Even when one network slice can realize low latency only in one private network, the low latency cannot be realized in E2E when the other private network side cannot realize the low latency. Therefore, it is necessary to examine what signaling and control are necessary.

### <1-4-8. Overview of Solution>

A management function for managing communication (congestion control manager (CCM)) using the network slice for low latency (hereinafter referred to as the network slice 1) is arranged in the private network A. The management function notifies the UPF1 configuring the network slice 1 or a node (e.g., UE) using the UPF1 about a low-latency guarantee.

For example, the management function of the private network A acquires information on a load state of the UPF1. When the UPF1 is determined to be low load, a permission for a predetermined operation is notified to the UPF1 or the node using the UPF1. For example, when it is determined that the UPF1 has the low load, the management function may notify the UPF1 that allocation of a new node is permitted. In addition, when it is determined that the UPF1 has the low load, the management function may notify the node using the UPF1 that a traffic using the UPF1 is permitted to be generated. At this time, the management function acquires a measurement result related to the throughput and a measurement result related to the packet size as UPF1 load state information, and determines that the UPF1 has the low load when the measurement result related to the throughput and the measurement result related to the packet size satisfy a predetermined criteria. The measurement result related to the packet size may be an average packet size or a distribution of packet sizes. Since the information on the throughput of the UPF and the packet size of the traffic is used to evaluate the load state, the state of the network slice 1 can be accurately maintained in the low load state. As a result, the low-latency communication can be provided.

Further, the private network A may be connected to the private network B. At this time, the management function of the private network A may acquire information on the load state of the UPF1 of the private network A (hereinafter also referred to as a first UPF1), and may acquire information on the load state of the UPF1 configuring the network slice 1 of the private network B (hereinafter also referred to as a second UPF1) from the management function of the private network B. When both the first UPF1 and the second UPF1 are determined to have the low load, the management function of the private network A notifies the first UPF1 or the node using the first UPF1 of a permission for the predetermined operation. As a result, even when a plurality of private networks is connected, it is possible to provide low-latency communication.

In addition, the management function may notify the node using the UPF1 of control of traffic generation at an application level in the node. When the private network A and the private network B are connected, the management function of the private network A may obtain, from the management function of the private network B, information related to the control of traffic generation at the application level in a node with respect to the node using the second UPF1. As a result, packet generation is controlled at the application level, so that overlapping of packet transmission/reception timings can be prevented. As a result, the low latency can be guaranteed not stochastically but deterministically.

### 2. Configuration of Communication System

Although the outline of the present embodiment has been described above, before the present embodiment is described in detail, a configuration of a communication system 1 including an information processing apparatus of the present embodiment will be described. Note that the communication system can be rephrased as an information processing system.

### <2-1. Configuration Example of Communication System>

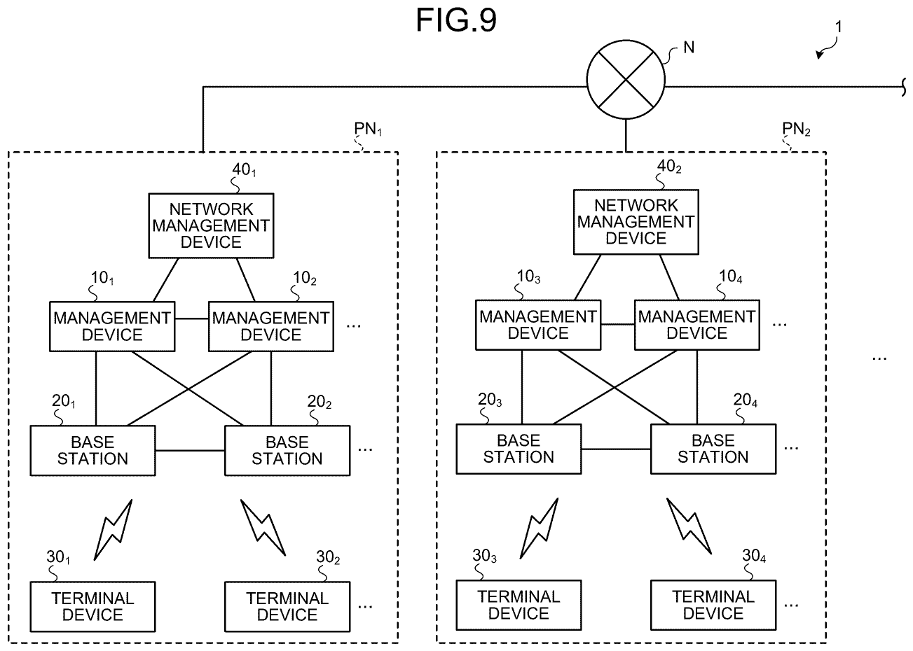

FIG. 9 is a diagram illustrating a configuration example of the communication system 1 according to the embodiment of the present disclosure. The communication system 1 includes a plurality of private networks PN. The private network PN is, for example, a private network using cellular wireless communication such as 4G or 5G. The plurality of private networks PN is connected via a network N. Although only one network N is illustrated in the example in FIG. 9, a plurality of networks N may exist.

Here, the network N is, for example, a public network such as the Internet. Note that the network N is not limited to the Internet, and may be, for example, a local area network (LAN), a wide area network (WAN), a cellular network, a fixed telephone network, or a regional Internet protocol (IP) network. The networks N may include a wired network or a wireless network.

In each of the plurality of private networks PN, a management device 10, a base station 20, a terminal device 30, and a network management device 40 are disposed. The communication system 1 provides a user with a wireless network capable of mobile communication by coordinated operation of wireless communication apparatuses configuring the communication system 1. The wireless network of the present embodiment includes, for example, a radio access network and a core network. Note that, in the present embodiment, the wireless communication apparatus is an apparatus having a function of wireless communication, and corresponds to the base station 20, and the terminal device 30 in the example in FIG. 9.

The communication system 1 may include a plurality of management devices 10, a plurality of base stations 20, a plurality of terminal devices 30, and a plurality of network management devices 40. In the example in FIG. 9, the communication system 1 includes management devices 101 and 102 as the management device 10, and includes base stations 201 and 202 as the base station 20. Furthermore, the communication system 1 includes terminal devices 301, 302, 303, and the like as the terminal device 30, and includes a network management device 401, a network management device 402, and the like as the network management device 40.

Note that devices in the drawings may be considered as devices in a logical sense. In other words, a part of the devices in the drawing may be realized by a virtual machine (VM), a container, a docker, or the like, and they may be implemented on physically the same hardware.

Note that the communication system 1 may support the radio access technology (RAT) such as long term evolution (LTE) or new radio (NR). The LTE and NR are types of cellular communication technology, and enable mobile communication of a terminal device by arranging a plurality of cellular areas covered by a base station. Note that a radio access method used by the communication system 1 is not limited to the LIE and NR, and may be another radio access method such as wideband code division multiple access (W-CDMA) or code division multiple access 2000 (cdma 2000).

Furthermore, the base station or a relay station configuring the communication system 1 may be a ground station or a non-ground station. The non-ground station may be a satellite station or an aircraft station. When the non-ground station is the satellite station, the communication system 1 may be a bent-pipe (transparent) type mobile satellite communication system.

In the present embodiment, the ground station (also referred to as a ground base station.) refers to a base station (including the relay station) installed on the ground. Here, the “ground” is a ground in a broad sense including not only land but also underground, water, and underwater. Note that, in the following description, the “ground station” may be replaced with a “gateway”.

Note that an LTE base station may be referred to as an evolved node B (eNodeB) or an eNB. Further, an NR base station may be referred to as a gNodeB or a gNB. In the LIE and NR, the terminal device (also referred to as a mobile station or a terminal) may be referred to as user equipment (UE). Note that the terminal device is a type of communication apparatus, and is also referred to as a mobile station or a terminal.

In the present embodiment, the concept of the communication apparatus includes not only a portable mobile device (terminal device) such as a mobile terminal but also a device installed in a structure or a mobile body. The structure or the mobile body itself may be regarded as the communication apparatus. In addition, the concept of the communication apparatus also includes the base station and the relay station in addition to the terminal device. The communication apparatus is one type of processor and information processor. Furthermore, the communication apparatus can be rephrased as a transmission device or a reception device.

Hereinafter, a configuration of each device configuring the communication system 1 will be specifically described. Note that the configuration of each device described below is merely an example. The configuration of each device may be different from the following configuration.

### <2-2. Configuration of Management Device>

Next, a configuration of the management device 10 will be described.

The management device 10 is an information processing apparatus (computer) that manages the wireless network. For example, the management device 10 is an information processing apparatus that manages communication of the base station 20. The management device 10 may be, for example, a device having a function as a mobility management entity (MME). The management device 10 may be a device having a function as an access and mobility management function (AMF) and/or a session management function (SMF). Naturally, functions of the management device 10 are not limited to the MME, the AMF, and the SMF. The management device 10 may be a device having a function as a network slice selection function (NSSF), an authentication server function (AUSF), a policy control function (PCF), or a unified data management (UDM). Furthermore, the management device 10 may be a device having a function as a home subscriber server (HSS). In addition, the management device 10 may have a management function (congestion control manager (CCM)) provided in the network management device 40 and function as the network management device 40. The CCM is a management function that manages communication using a predetermined network slice (e.g., network slice for low latency).

Note that the management device 10 may have a function of the gateway. For example, the management device 10 may have a function as a serving gateway (S-GW) or a packet data network gateway (P-GW). In addition, the management device 10 may have a function of the user plane function (UPF). In this case, the management device 10 may have a plurality of UPFs. Each of the plurality of UPFs may function as a UPF resource of a different network slice. In addition, the management device 10 may have a function of the congestion control manager (CCM).

The core network includes a plurality of network functions, and each network function may be aggregated into one physical device or distributed to a plurality of physical devices. In other words, the management device 10 can be dispersedly arranged in a plurality of devices. Further, this distributed arrangement may be controlled to be performed dynamically. The base station 20 and the management device 10 configure one network, and provide a wireless communication service to the terminal device 30. The management device 10 is connected to the Internet, and the terminal device 30 can use various services provided via the Internet via the base station 20.

Note that the management device 10 is not necessarily a device configuring the core network. For example, it is assumed that the core network is a wideband code division multiple access (W-CDMA) or code division multiple access 2000 (cdma 2000) core network. In this case, the management device 10 may be a device that functions as a radio network controller (RNC).

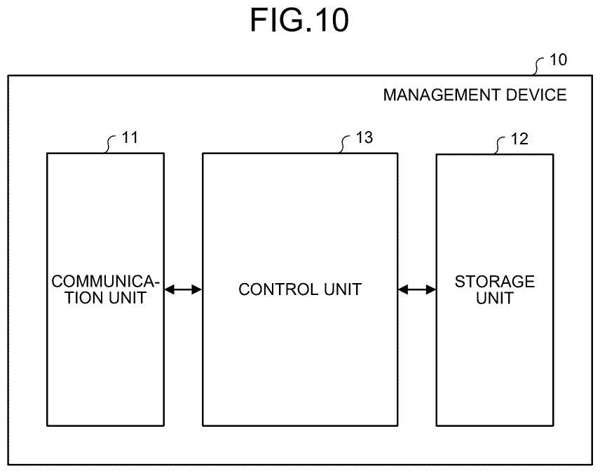

FIG. 10 is a diagram illustrating a configuration example of the management device 10 according to the embodiment of the present disclosure. The management device 10 includes a communication unit 11, a storage unit 12, and a control unit 13. Note that the configuration illustrated in FIG. 10 is a functional configuration, and a hardware configuration may be different from the functional configuration. Furthermore, functions of the management device 10 may be implemented in a statistically or dynamically distributed manner in a plurality of physically separated structures. For example, the management device 10 may include a plurality of server devices.

The communication unit 11 is a communication interface for communicating with other devices. The communication unit 11 may be a network interface or a device connection interface. For example, the communication unit 11 may be a local area network (LAN) interface such as a network interface card (NIC), or may be a universal serial bus (USB) interface including a USB host controller and a USB port. Furthermore, the communication unit 11 may be a wired interface or a wireless interface. The communication unit 11 functions as a communication means of the management device 10. The communication unit 11 communicates with the base station 20 and the like under the control of the control unit 13.

The storage unit 12 is a data readable/writable storage device such as a dynamic random access memory (DRAM), a static random access memory (SRAM), a flash memory, or a hard disk. The storage unit 12 functions as a storage means of the management device 10. The storage unit 12 stores, for example, a connection state of the terminal device 30. For example, the storage unit 12 stores a radio resource control (RRC) state or an EPS connection management (ECM) state or a 5G system connection management (CM) state of the terminal device 30. The storage unit 12 may function as a home memory that stores position information of the terminal device 30.

The control unit 13 is a controller that controls each part of the management device 10. The control unit 13 is realized by, for example, a processor such as a central processing unit (CPU), a micro processing unit (MPU), or a graphics processing unit (GPU). For example, the control unit 13 is implemented by a processor executing various programs stored in the storage device inside the management device 10 using a random access memory (RAM) or the like as a work area. Note that the control unit 13 may be realized by an integrated circuit such as an application specific integrated circuit (ASIC) or a field programmable gate array (FPGA). Any of the CPU, the MPU, the GPU, the ASIC, and the FPGA can be regarded as the controller.

### <2-3. Configuration Example of Base Station>

Next, a configuration of the base station 20 will be described.

The base station 20 is a wireless communication apparatus that performs wireless communication with the terminal device 30. The base station 20 may be configured to wirelessly communicate with the terminal device 30 via the relay station, or may be configured to wirelessly communicate with the terminal device 30 directly.

The base station 20 is one type of the communication apparatus. The base station 20 is, for example, a device corresponding to a radio base station (e.g., base station, Node B, eNB, and gNB) or a radio access point. The base station 20 may be a wireless relay station. Furthermore, the base station 20 may be an optical extension device called a remote radio head (RRH) or a radio unit (RU). Furthermore, the base station 20 may be a receiving station such as a field pickup unit (FPU). Furthermore, the base station 20 may be an integrated access and backhaul (IAB) donor node or an IAB relay node that provides a radio access line and a radio backhaul line by time division multiplexing, frequency division multiplexing, or space division multiplexing.

Note that the radio access technology used by the base station 20 may be the cellular communication technology or the wireless LAN technology. Obviously, the radio access technology used by the base station 20 is not limited thereto, and may be other radio access technologies. For example, the radio access technology used by the base station 20 may be a low power wide area (LPWA) communication technology. In addition, the wireless communication used by the base station 20 may be wireless communication using millimeter waves. Furthermore, the wireless communication used by the base station 20 may be wireless communication using radio waves or wireless communication (optical) using infrared rays or visible light. The base station 20 may be capable of non-orthogonal multiple access (NOMA) communication with the terminal device 30. Here, the NOMA communication is communication using a non-orthogonal resource (transmission, reception, or both). Note that the base station 20 may be able to perform the NOMA communication with another base station 20.

Note that the base stations 20 may be capable of communicating with each other via a base station-core network interface (e.g., NG Interface and S1 Interface). This interface may be either wired or wireless. Furthermore, the base stations may be capable of communicating with each other via an inter-base station interface (e.g., Xn Interface, X2 Interface, S1 Interface, and F1 Interface). This interface may be either wired or wireless.

Note that the concept of the base station includes not only a donor base station but also a relay base station (also referred to as the relay station). For example, the relay base station may be any one of RF repeater, smart repeater, and intelligent surface. In addition, the concept of the base station includes not only a structure having a function of the base station but also a device installed in the structure.

The structure is, for example, a building such as a high-rise building, a house, a steel tower, a station facility, an airport facility, a harbor facility, an office building, a school building, a hospital, a factory, a commercial facility, or a stadium. Note that the concept of the structure includes not only a building but also a non-building structure such as a tunnel, a bridge, a dam, a wall, or an iron pillar, and equipment such as a crane, a gate, or a windmill. In addition, the concept of the structure includes not only a structure on land (on the ground in a narrow sense) or underground, but also a structure on water such as a platform or a megafloat, and a structure under water such as a marine observation facility. The base station can be rephrased as the information processing apparatus.

The base station 20 may be the donor station or the relay station. Furthermore, the base station 20 may be a fixed station or a mobile station. The mobile station is a wireless communication apparatus (e.g., base station) configured to be movable. In this case, the base station 20 may be a device installed in the mobile body or may be the mobile body itself. For example, the relay station having mobility can be regarded as the base station 20 as the mobile station. In addition, a device that is originally a device having the mobility and has a function of the base station (at least a part of the function of the base station), such as a vehicle, an unmanned aerial vehicle (UAV) as typified by a drone, or a smartphone, also corresponds to the base station 20 as the mobile station.

Here, the mobile body may be a mobile terminal such as a smartphone or a mobile phone. In addition, the mobile body may be a mobile body that travels on land (ground in a narrow sense) (e.g., vehicle including an automobile, a bicycle, a bus, a truck, a motorcycle, a train, and a linear motor car) or a mobile body (e.g., subway) that travels underground (e.g., inside tunnel). In addition, the mobile body may be a mobile body that travels on water (e.g., ship such as a passenger ship, a cargo ship, or a hovercraft) or a mobile body that moves under water (e.g., submersibles such as a submersible vessel, a submarine, and an unmanned submarine). Note that the mobile body may be a mobile body (e.g., aircraft such as an airplane, an airship, or a drone) that moves in the atmosphere.

Furthermore, the base station 20 may be a ground base station device (ground station) installed on the ground. For example, the base station 20 may be a base station installed in a structure on the ground, or may be a base station installed in a mobile body moving on the ground. More specifically, the base station 20 may be an antenna installed in a structure such as a building and a signal processing device connected to the antenna. Obviously, the base station 20 may be the structure or the mobile body itself. The “ground” in a broad sense includes not only land (ground in a narrow sense) but also underground, on water, and under water. Note that the base station 20 is not limited to the ground base station. For example, when the communication system 1 is a satellite communication system, the base station 20 may be an aircraft station. From the perspective of the satellite station, the aircraft station located on the earth is a ground station.

Note that the base station 20 is not limited to the ground station. The base station 20 may be a non-ground base station (non-ground station) capable of floating in the air or space. For example, the base station 20 may be an aircraft station or a satellite station.

The satellite station is a satellite station capable of floating outside the atmosphere. The satellite station may be a device mounted on a space mobile body such as an artificial satellite, or may be the space mobile body itself. The space mobile body is a mobile body that moves outside the atmosphere. Examples of the space mobile body include artificial bodies such as an artificial satellite, a spacecraft, a space station, and a probe. The satellite serving as the satellite station may be any of a low earth orbiting (LEO) satellite, a medium earth orbiting (MEO) satellite, a geostationary earth orbiting (GEO) satellite, and a highly elliptical orbiting (HEO) satellite. Obviously, the satellite station may be a device mounted on the LEO satellite, the MEO satellite, the GEO satellite, or the HEO satellite.

The aircraft station is a wireless communication apparatus capable of floating in the atmosphere, such as an aircraft. The aircraft station may be a device mounted on an aircraft or the like, or may be the aircraft itself. Note that the concept of the aircraft includes not only a heavy aircraft such as an airplane and a glider but also a light aircraft such as a balloon and an airship. In addition, the concept of the aircraft includes not only heavy and light aircrafts but also a rotorcraft such as a helicopter and an autogyroscope. Note that the aircraft station (or the aircraft on which an aircraft station is mounted) may be an unmanned aerial vehicle such as a drone.

Note that the concept of the unmanned aerial vehicle also includes an unmanned aircraft system (UAS) and a tethered UAS. The concept of the unmanned aerial vehicle also includes lighter than air (LTA) UAS and heavier than air (HTA) UAS. Furthermore, the concept of unmanned aerial vehicles also includes high altitude UAS platforms (HAPs).

A coverage of the base station 20 may be large such as a macro cell to small such as a pico cell. It is apparent that a magnitude of the coverage of the base station 20 may be extremely small such as a femto cell. Further, the base station 20 may have a beamforming capability. In this case, the base station 20 may form a cell or a service area for each beam.

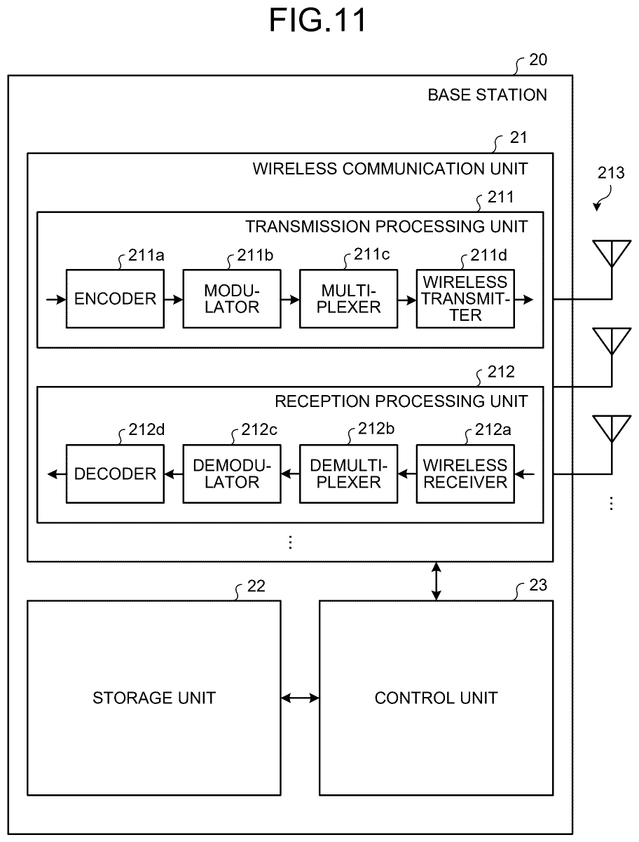

FIG. 11 is a diagram illustrating a configuration example of the base station 20 according to the embodiment of the present disclosure. The base station 20 includes a wireless communication unit 21, a storage unit 22, and a control unit 23. Note that the configuration illustrated in FIG. 11 is a functional configuration, and the hardware configuration may be different from the functional configuration. Furthermore, functions of the base station 20 may be implemented in a distributed manner in a plurality of physically separated configurations.

The wireless communication unit 21 is a signal processing unit for wirelessly communicating with another wireless communication apparatus (e.g., terminal device 30). The wireless communication unit 21 operates under the control of the control unit 23. The wireless communication unit 21 corresponds to one or a plurality of radio access methods. For example, the wireless communication unit 21 supports both NR and LTE. The wireless communication unit 21 may be compatible with W-CDMA or cdma 2000 in addition to the NR or LTE. Furthermore, the wireless communication unit 21 may support an automatic retransmission technology such as hybrid automatic repeat request (HARQ).

The wireless communication unit 21 includes a transmission processing unit 211, a reception processing unit 212, and an antenna 213. The wireless communication unit 21 may include a plurality of transmission processing units 211, a plurality of reception processing units 212, and a plurality of antennas 213. When the wireless communication unit 21 supports the plurality of radio access methods, each part of the wireless communication unit 21 can be configured individually for each of the radio access methods. For example, the transmission processing unit 211 and the reception processing unit 212 may be individually configured for the LTE and the NR. Furthermore, the antenna 213 may include a plurality of antenna elements (e.g., a plurality of patch antennas). In this case, the wireless communication unit 21 may be configured to be beamformable. The wireless communication unit 21 may be configured to be able to perform polarization beamforming using vertically polarized waves (V-polarized waves) and horizontally polarized waves (H-polarized waves).

The transmission processing unit 211 performs transmission processing of downlink control information and downlink data. The transmission processing unit 211 encodes the downlink control information and the downlink data input from the control unit 23 using an encoding system such as block encoding, convolutional encoding, or turbo encoding. Here, the encoding may be performed by polar code encoding or low density parity check code (LDPC code) encoding. Then, the transmission processing unit 211 modulates coded bits by a predetermined modulation scheme such as BPSK, QPSK, 16QAM, 64QAM, or 256QAM. In this case, signal points on constellation do not necessarily have to be equidistant. The constellation may be a non-uniform constellation (NUC). The transmission processing unit 211 multiplexes a modulation symbol of each channel and a downlink reference signal, and arranges a multiplexed result in a predetermined resource element. Then, the transmission processing unit 211 performs various types of signal processing on a multiplexed signal. For example, the transmission processing unit 211 performs processing such as conversion into a frequency domain by fast Fourier transform, addition of a guard interval, generation of a baseband digital signal, conversion into an analog signal, quadrature modulation, up-conversion, removal of an extra frequency component, and power amplification. A signal generated by the transmission processing unit 211 is transmitted from the antenna 213.

The reception processing unit 212 processes an uplink signal received via the antenna 213. The reception processing unit 212 performs, with respect to the uplink signal, down-conversion, removal of an unnecessary frequency component, control of an amplification level, quadrature demodulation, conversion into a digital signal, removal of a guard interval (cyclic prefix), extraction of a frequency domain signal by fast Fourier transform, and the like. In this case, the reception processing unit 212 separates an uplink channel, such as a physical uplink shared channel (PUSCH) and a physical uplink control channel (PUCCH), and an uplink reference signal from a signal after the above processing is performed. The reception processing unit 212 demodulates a received signal using a modulation scheme such as binary phase shift keying (BPSK) or quadrature phase shift keying (QPSK) with respect to a modulation symbol of the uplink channel. The modulation scheme used for demodulation may be 16-quadrature amplitude modulation (16QAM), 64QAM, or 256QAM. In this case, signal points on constellation do not necessarily have to be equidistant. The constellation may be a non-uniform constellation (NUC). The reception processing unit 212 decodes encoded bits of a demodulated uplink channel. Decoded uplink data and uplink control information are output to the control unit 23.

The antenna 213 is an antenna device (antenna unit) that mutually converts a current and a radio wave. The antenna 213 may include one antenna element (e.g., one patch antenna) or may include a plurality of antenna elements (e.g., a plurality of patch antennas). In a case where the antenna 213 includes a plurality of antenna elements, the wireless communication unit 21 may be configured to be beamformable. For example, the wireless communication unit 21 may be configured to generate a directional beam by controlling the directivity of a radio signal using the plurality of antenna elements. Note that the antenna 213 may be a dual-polarized antenna. When the antenna 213 is a dual-polarized antenna, the wireless communication unit 21 may use vertically polarized waves (V-polarized waves) and horizontally polarized waves (H-polarized waves) to transmit radio signals. Then, the wireless communication unit 21 may control directivity of the radio signal transmitted using the vertically polarized wave and the horizontally polarized wave. Furthermore, the wireless communication unit 21 may transmit and receive spatially multiplexed signals via a plurality of layers including the plurality of antenna elements.

The storage unit 22 is a storage device capable of reading and writing data, such as a DRAM, an SRAM, a flash memory, or a hard disk. The storage unit 22 functions as a storage means of the base station 20.

The control unit 23 is a controller that controls each part of the base station 20. The control unit 23 is realized by, for example, a processor such as a central processing unit (CPU) or a micro processing unit (MPU). For example, the control unit 23 is implemented by a processor executing various programs stored in the storage device inside the base station 20 using the random access memory (RAM) or the like as a work area. Note that the control unit 23 may be realized by an integrated circuit such as an application specific integrated circuit (ASIC) or a field programmable gate array (FPGA). Any of the CPU, the MPU, the ASIC, and the FPGA can be regarded as the controller. Furthermore, the control unit 23 may be realized by a graphics processing unit (GPU) in addition to or instead of the CPU.

In some embodiments, the concept of a base station may consist of a collection of multiple physical or logical devices. For example, in this embodiment, the base station may be distinguished into a plurality of devices such as a baseband unit (BBU) and a radio unit (RU). Then, the base station may be interpreted as an assembly of the plurality of devices. In addition, the base station may be either or both of the BBU and the RU. The BBU and the RU may be connected by a predetermined interface (e.g., enhanced common public radio interface (eCPRI)). The RU may be rephrased as a remote radio unit (RRU) or a radio DoT (RD). Furthermore, the RU may correspond to a gNB distributed unit (gNB-DU) described later. Further, the BBU may correspond to a gNB central unit (gNB-CU) described later. Alternatively, the RU may be a wireless device connected to the gNB-DU described later. The gNB-CU, the gNB-DU, and the RU connected to the gNB-DU may be configured to conform to an open radio access network (O-RAN). Further, the RU may be a device integrally formed with the antenna. The antenna (e.g., antenna integrally formed with RU) included in the base station may adopt an advanced antenna system and support MIMO (e.g., FD-MIMO) or beamforming. Furthermore, the antenna included in the base station may include, for example, 64 transmission antenna ports and 64 reception antenna ports.

In addition, the antenna mounted on the RU may be an antenna panel including one or more antenna elements, and the RU may be mounted with one or more antenna panels. For example, the RU may be mounted with two antenna panels of a horizontally polarized antenna panel and a vertically polarized antenna panel, or two antenna panels of a clockwise circularly polarized antenna panel and a counterclockwise circularly polarized antenna panel. In addition, the RU may form and control an independent beam for each antenna panel.

Note that a plurality of base stations may be connected to each other. The one or more base stations may be included in a radio access network (RAN). In this case, the base station may be simply referred to as a RAN, a RAN node, an access network (AN), or an AN node. Note that the RAN in the LTE is sometimes referred to as an enhanced universal terrestrial RAN (EUTRAN). In addition, the RAN in the NR may be referred to as NGRAN. In addition, the RAN in the W-CDMA (UMTS) is sometimes referred to as UTRAN.

Note that an LTE base station may be referred to as an evolved node B (eNodeB) or an eNB. In this case, the EUTRAN includes one or more eNodeBs (eNBs). Further, an NR base station may be referred to as a gNodeB or a gNB. In this case, the NGRAN includes one or more gNBs. The EUTRAN may include the gNB (en-gNB) connected to the core network (EPC) in an LTE communication system (EPS). Similarly, the NGRAN may include an ng-eNB connected to a core network 5GC in a 5G communications system (5GS).

When the base station is the eNB, the gNB, or the like, the base station may be referred to as a 3GPP access. In addition, when the base station is the radio access point, the base station may be referred to as a non-3GPP access. Further, the base station may be an optical extension device called a remote radio head (RRH) or a radio unit (RU). Furthermore, in a case where the base station is the gNB, the base station may be a combination of the gNB-CU and the gNB-DU described above, or may be any one of the gNB-CU and the gNB-DU.

Here, the gNB-CU hosts a plurality of upper layers (e.g., radio resource control (RRC), service data adaptation protocol (SDAP), and packet data convergence protocol (PDCP)) in an access stratum for communication with the UE. On the other hand, the gNB-DU hosts a plurality of lower layers (e.g., radio link control (RLC), medium access control (MAC), and physical layer (PHY) in an access stratum. In other words, among messages/information to be described later, RRC signaling (semi-static notification) may be generated by the gNB-CU, while MAC CE and DCI (dynamic notification) may be generated by the gNB-DU. Alternatively, in the RRC configuration (semi-static notification), for example, some configurations such as IE: cellGroupConfig may be generated by the gNB-DU, and the remaining configurations may be generated by the gNB-CU. These configurations may be transmitted and received through an F1 interface described later.

Note that the base station may be configured to be able to communicate with another base station. For example, when a plurality of base stations is the eNBs or a combination of the eNB and the en-gNB, the base stations may be connected by an X2 interface. Furthermore, in a case where a plurality of base stations are the gNBs or a combination of the gn-eNB and the gNB, the devices may be connected by an Xn interface. Furthermore, in a case where a plurality of base stations is a combination of the gNB-CU and the gNB-DU, the devices may be connected by the above-described F1 interface. A message/information (e.g., RRC signaling, MAC control element (MAC CE), or DCI) to be described later may be transmitted between a plurality of base stations, for example, via the X2 interface, the Xn interface, or the F1 interface.

The cell provided by the base station is referred to as, for example, a serving cell. The serving cell may include a primary cell (PCell) and a secondary cell (SCell). When dual connectivity is configured for the UE (e.g., terminal device 30), the PCell provided by a master node (MN) and zero or one or more SCells may be referred to as a master cell group. Examples of the dual connectivity include EUTRA-EUTRA dual connectivity, EUTRA-NR dual connectivity (ENDC), EUTRA-NR dual connectivity with 5GC, NR-EUTRA dual connectivity (NEDC), and NR-NR dual connectivity.

Further, the serving cell may include a primary secondary cell (PSCell) or primary SCG cell. In other words, when the dual connectivity is set to the UE, the PSCell provided by the secondary node (SN) and zero or one or more SCells are referred to as a secondary cell group (SCG). Unless specially configured (e.g., PUCCH on SCell), a physical uplink control channel (PUCCH) is transmitted in the PCell and the PSCell, but is not transmitted in the SCell. In addition, a radio link failure is also detected in the PCell and the PSCell, but is not detected in the SCell (may not be detected). As described above, since the PCell and the PSCell have a special role in the serving cell, they are also referred to as a special cell (SpCell).

In one cell, one downlink component carrier and one uplink component carrier may be associated. Further, a system bandwidth corresponding to one cell may be divided into a plurality of bandwidth parts (BWP). In this case, one or more BWPs may be set to the UE, and the UE may use one BWP as an active BWP. In addition, radio resources that can be used by the terminal device 30 (e.g., frequency bandwidth, numerology (subcarrier spacing), and slot configuration) may be different for each cell, each component carrier, or each BWP.

### <2-4. Configuration Example of Terminal Device>

Next, a configuration of the terminal device 30 will be described. The terminal device 30 can be rephrased as a user equipment (UE) 30.

The terminal device 30 is a wireless communication apparatus that wirelessly communicates with other communication apparatuses such as the base station 20. For example, the terminal device 30 may be a mobile phone, a smart device (smartphone or tablet), a personal digital assistant (PDA), or a personal computer. Furthermore, the terminal device 30 may be a device such as a business-use camera provided with a communication function, or may be a motorcycle, a moving relay vehicle, or the like on which communication equipment such as a field pickup unit (FPU) is mounted. Furthermore, the terminal device 30 may be a machine-to-machine (M2M) device or an Internet of Things (IoT) device.

Note that the terminal device 30 may be capable of performing NOMA communication with the base station 20. Furthermore, the terminal device 30 may be capable of using an automatic retransmission technology such as HARQ when communicating with the base station 20. Further, the terminal device 30 may be capable of performing sidelink communication with another terminal device 30. The terminal device 30 may also be capable of using an automatic retransmission technology such as HARQ when performing the sidelink communication. Note that the terminal device 30 may also be capable of the NOMA communication in communication (sidelink) with other terminal devices 30. Furthermore, the terminal device 30 may be capable of performing LPWA communication with other communication apparatuses (e.g., base station 20 and other terminal devices 30). Furthermore, wireless communication used by the terminal device 30 may be wireless communication using millimeter waves. Note that the radio communication (including the sidelink communication) used by the terminal device 30 may be radio communication using radio waves or radio communication (optical) using infrared rays or visible light.

Furthermore, the terminal device 30 may be a mobile device. The mobile device is a mobile wireless communication apparatus. In this case, the terminal device 30 may be the radio communication apparatus installed in the mobile body or may be the mobile body itself. For example, the terminal device 30 may be a vehicle that moves on a road, such as an automobile, a bus, a truck, or a motorcycle, or a wireless communication apparatus mounted on the vehicle. Note that the mobile body may be a mobile terminal, or may be the mobile body that travels on land (on the ground in a narrow sense), underground, on water, or under water. Furthermore, the mobile body may be a mobile body that travels in the atmosphere, such as a drone or a helicopter, or may be a mobile body that travels outside the atmosphere such as an artificial satellite.

The terminal device 30 may be simultaneously connected to a plurality of base stations or a plurality of cells to perform communication. For example, when one base station supports a communication area via a plurality of cells (e.g., pCell and sCell), it is possible to bundle the plurality of cells and communicate between the base station 20 and the terminal device 30 by a carrier aggregation (CA) technology, a dual connectivity (DC) technology, or a multi-connectivity (MC) technology. Alternatively, the terminal device 30 and the plurality of base stations 20 can communicate with each other by a coordinated multi-point transmission and reception (COMP) technology via cells of different base stations 20.

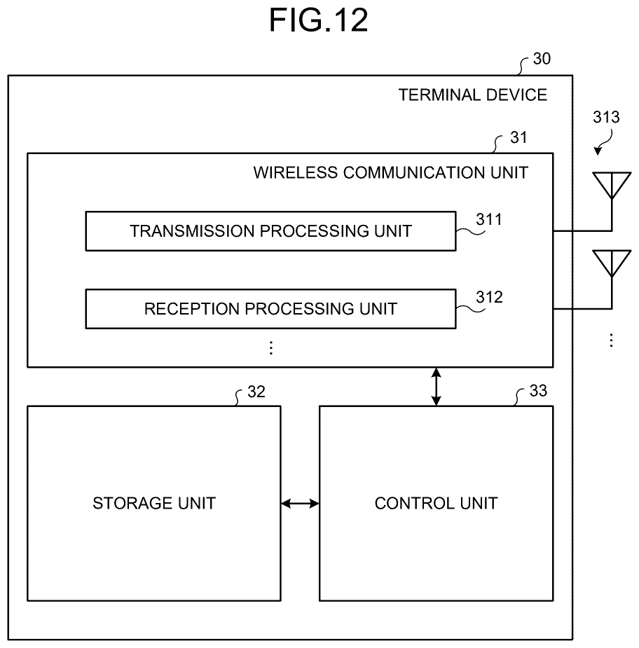

FIG. 12 is a diagram illustrating a configuration example of the terminal device 30 according to the embodiment of the present disclosure. The terminal device 30 includes a wireless communication unit 31, a storage unit 32, and a control unit 33. Note that the configuration illustrated in FIG. 12 is a functional configuration, and the hardware configuration may be different from the functional configuration. Furthermore, functions of the terminal device 30 may be implemented in a distributed manner in a plurality of physically separated structures.

The wireless communication unit 31 is a signal processing unit for wirelessly communicating with other wireless communication apparatuses (e.g., base station 20 and other terminal devices 30). The wireless communication unit 31 operates under the control of the control unit 33. The wireless communication unit 31 includes a transmission processing unit 311, a reception processing unit 312, and an antenna 313. Configurations of the wireless communication unit 31, the transmission processing unit 311, the reception processing unit 312, and the antenna 313 may be similar to those of the wireless communication unit 21, the transmission processing unit 211, the reception processing unit 212, and the antenna 213 of the base station 20. Further, the wireless communication unit 31 may be configured to be beamformable similarly to the wireless communication unit 21. Further, similarly to the wireless communication unit 21, the wireless communication unit 31 may be configured to be capable of transmitting and receiving spatially multiplexed signals.

The storage unit 32 is a storage device capable of reading and writing data such as the DRAM, the SRAM, the flash memory, or the hard disk. The storage unit 32 functions as a storage means of the terminal device 30.

The control unit 33 is a controller that controls each part of the terminal device 30. The control unit 33 is realized by, for example, a processor such as the CPU or the MPU. For example, the control unit 33 is realized by a processor executing various programs stored in a storage device inside the terminal device 30 using the RAM or the like as a work area. Note that the control unit 33 may be realized by an integrated circuit such as the ASIC or the FPGA. Any of the CPU, the MPU, the ASIC, and the FPGA can be regarded as the controller. Furthermore, the control unit 33 may be realized by the GPU in addition to or instead of the CPU.

### <2-5. Configuration Example of Network Management Device>

Next, a configuration of the network management device 40 will be described.

The network management device 40 is an information processing apparatus (computer) including a management function private network that manages communication using a predetermined network slice (e.g., network slice for low latency). For example, the network management device 40 is a server installed by an administrator who manages the private network. The network management device 40 may be a node configuring a core network in the private network.

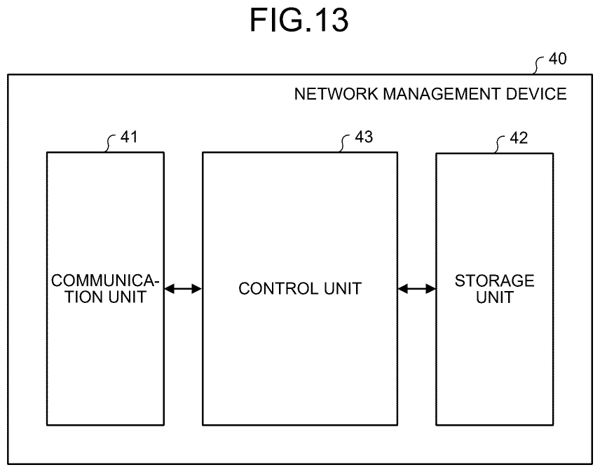

FIG. 13 is a diagram illustrating a configuration example of the network management device 40 according to the embodiment of the present disclosure. The network management device 40 includes a communication unit 41, a storage unit 42, and a control unit 43. Note that the configuration illustrated in FIG. 13 is a functional configuration, and a hardware configuration may be different from the functional configuration. Furthermore, functions of the network management device 40 may be implemented in a statistically or dynamically distributed manner in a plurality of physically separated structures. For example, the network management device 40 may include a plurality of server devices.

The communication unit 41 is a communication interface for communicating with other devices. The communication unit 41 may be a network interface or a device connection interface. For example, the communication unit 41 may be a local area network (LAN) interface such as a network interface card (NIC), or may be a universal serial bus (USB) interface including a USB host controller and a USB port. Furthermore, the communication unit 41 may be a wired interface or a wireless interface. The communication unit 41 functions as a communication means of the network management device 40. The communication unit 41 communicates with the management device 10 according to the control of the control unit 43.

The storage unit 42 is a data readable/writable storage device such as a dynamic random access memory (DRAM), a static random access memory (SRAM), a flash memory, or a hard disk. The storage unit 42 functions as a storage means of the network management device 40.

The control unit 43 is a controller that controls each part of the network management device 40. The control unit 43 is realized by, for example, a processor such as a central processing unit (CPU), a micro processing unit (MPU), or a graphics processing unit (GPU). For example, the control unit 43 is implemented by a processor executing various programs stored in the storage device inside the network management device 40 using a random access memory (RAM) or the like as a work area. Note that the control unit 43 may be realized by an integrated circuit such as an application specific integrated circuit (ASIC) or a field programmable gate array (FPGA). Any of the CPU, the MPU, the GPU, the ASIC, and the FPGA can be regarded as the controller.

### 3. Network Architecture

The configuration of the communication system 1 has been described above. Next, a network architecture applicable to the communication system 1 of the present embodiment will be described.

### <3-1. Configuration Example of 5G Network Architecture>

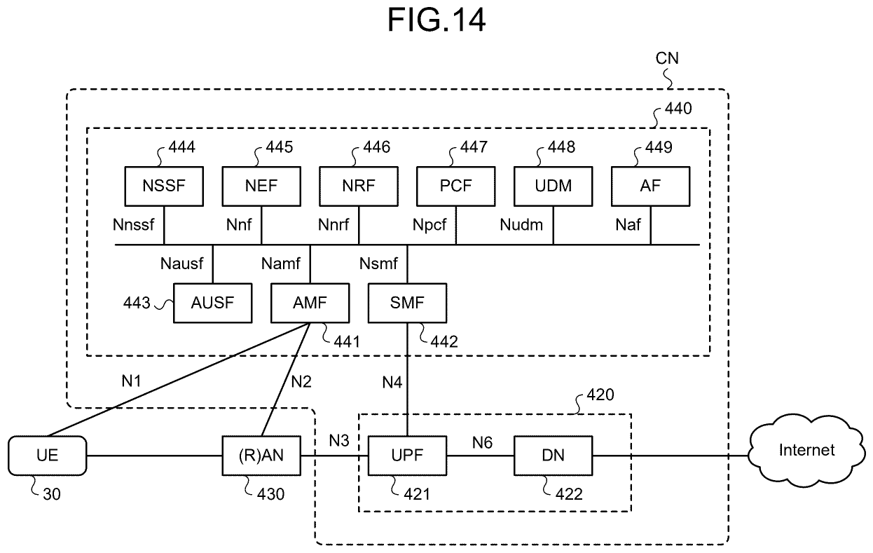

First, an architecture of a fifth generation mobile communication system (5G) will be described as an example of the core network CN of the communication system 1. FIG. 14 is a diagram illustrating an example of a 5G architecture. A 5G core network CN is also referred to as a 5G core/next generation core (5GC/NGC). Hereinafter, the 5G core network CN is also referred to as the 5GC/NGC. The core network CN is connected to the user equipment (UE) 30 via a (R) AN 430. The UE 30 is, for example, the terminal device 30. Note that the core network CN illustrated in FIG. 14 does not include the management function (congestion control manager (CCM)) for managing communication using a predetermined network slice (e.g., network slice for low latency), but the core network CN may include the CCM as one of network functions. Naturally, the CCM may be a network function disposed outside the core network CN.

The (R) AN 430 has a function of enabling connection to a radio access network (RAN) and connection to an access network (AN) other than the RAN. The (R) AN 430 includes a base station called the gNB or the ng-eNB.

The core network CN mainly performs connection permission and session management when the UE 30 is connected to the network. The core network CN includes a user plane function group 420 and a control plane function group 440.

The user plane function group 420 includes a user plane function (UPF) 421 and a data network (DN) 422. The UPF 421 has a function of user plane processing. The UPF 421 includes a routing/forwarding function of data handled in the user plane. A DN 422 has a function of providing an entity, such as a mobile network operator (MNO), that provides a connection to an operator's own service, providing an Internet connection, or providing a connection to a third party service. As described above, the user plane function group 420 plays a role of a gateway serving as a boundary between the core network CN and the Internet.

The control plane function group 440 includes an access management function (AMF) 441, a session management function (SMF) 442, an authentication server function (AUSF) 443, a network slice selection function (NSSF) 444, a network exposure function (NEF) 445, a network repository function (NRF) 446, a policy control function (PCF) 447, a unified data management (UDM) 448, and an application function (AF) 449.

The AMF 441 has functions such as registration processing, connection management, and mobility management of the UE 30. The SMF 442 has functions such as session management and IP assignment and management of the UE 30. The AUSF 443 has an authentication function. The NSSF 444 has a function related to selection of the network slice. The NEF 445 has a function of providing network function capabilities and events to a third party, an AF 449, and an edge computing function.

The NRF 446 has a function of finding a network function and holding a profile of the network function. The PCF 447 has a function of policy control. A UDM 448 has functions of generating 3GPP AKA authentication information and processing a user ID. The AF 449 has a function of interacting with the core network to provide a service.

For example, the control plane function group 440 acquires information from the UDM 448 in which subscriber information of the UE 30 is stored, and determines whether or not the UE 30 may be connected to the network. The control plane function group 440 uses contract information of the UE 30 and a key for encryption included in the information acquired from the UDM 448 for determination. In addition, the control plane function group 440 generates the key for encryption and the like.

In other words, for example, the control plane function group 440 determines whether or not the network can be connected according to whether or not information on the UE 30 associated with a subscriber number called an international mobile subscriber identity (IMSI) is stored in the UDM 448. Note that the IMSI is stored in, for example, a subscriber identity module (SIM) card in the UE 30.

Here, Namf is a service-based interface provided by the AMF 441, and Nsmf is a service-based interface provided by the SMF 442. In addition, Nnef is a service-based interface provided by the NEF 445, and Npcf is a service-based interface provided by the PCF 447. Nudm is a service-based interface provided by the UDM 448, and Naf is a service-based interface provided by the AF 449. Nnrf is a service-based interface provided by the NRF 446, and Nnssf is a service-based interface provided by the NSSF 444. Nausf is a service-based interface provided by the AUSF 443. Each of these network functions (NFs) exchanges information with another NF via each service-based interface.

In addition, N1 illustrated in FIG. 14 is a reference point between the UE 30 and the AMF 441, and N2 is a reference point between the RAN/AN 430 and the AMF 441. N4 is a reference point between the SMF 442 and the UPF 421, and information is exchanged between these network functions (NFs).

As described above, in the core network CN, an interface for transmitting information and controlling functions via an application programming interface (API) called a service-based interface is prepared.

The API specifies a resource and enables to perform GET (resource acquisition), POST (resource creation and data addition), PUT (resource creation and resource update), DELETE (resource deletion), and the like on the resource. These functions are generally used, for example, in a technical field related to the web.

For example, the AMF 441, the SMF 442, and the UDM 448 illustrated in FIG. 14 exchange information with each other using the API when establishing a communication session. Conventionally, it is not assumed that an application (e.g., AF 449) uses the API. However, when the AF 449 uses the API, the AF 449 can use information of a 5G cellular network, and it is considered that a function of the application can be further evolved.

Note that it is difficult for the AF 289 to use the API used by the AMF 441, the SMF 442, and the UDM 448 in the public network. However, in the case of a non-public private 5G network, it is considered that the system can be configured including, for example, a change in the API of the core network CN so that the AF 289 can use the API.

Here, an example of the API will be described. An API (1) to an API (4) described here are described in 3GPP TS 23.502.

### API (1)

The API (1) is the API in which the SMF 442 notifies that the UE 30 registered in advance transitions from a power off state to a power on state and attaches to the network and the IP address acquired at that time.

The SMF 442 uses the API (1) to notify the NF when the UE 30 of the registered IMSI obtains the IP address.

### API (2)

The UE 30 enters an idle mode when not communicating, and transitions to a connected mode when communicating. The API (2) is the API in which the AMF 441 notifies whether the UE 30 is in the idle mode or the connected mode.

### API (3)

The API (3) is the API for broadcasting a message (paging message), from the base station, for instructing the UE 30 to transition from the idle mode to the connected mode.

### API (4)

The API (4) is the API in which the AMF 441 provides position information of the UE 30. The AMF 441 may use the API (4) to inform which tracking area the UE 30 is located, which cell the UE 30 belongs to, and when the UE 30 enters a specific region.

Note that an example of the UE 30 in FIG. 14 is the terminal device 30 of the present embodiment. An example of the RAN/AN 430 is the base station 20 of the present embodiment. Furthermore, the management device 10 illustrated in FIG. 10 is an example of a device having a function of, for example, the AF 449 or the AMF 441.

### <3-2. Configuration Example of 4G Network Architecture>

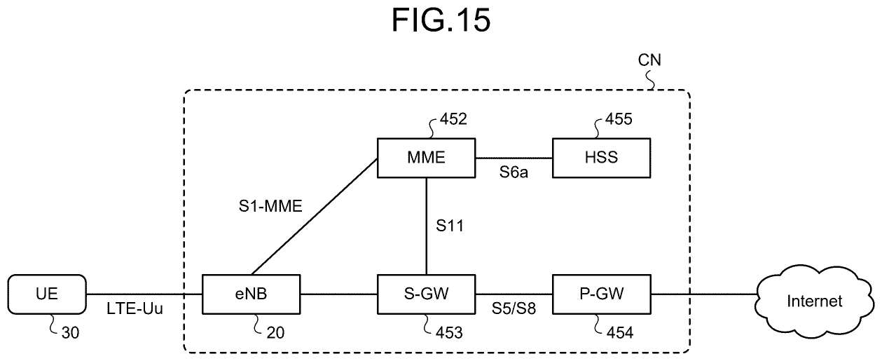

Next, an architecture of a fourth generation mobile communication system (4G) will be described, with reference to FIG. 15 as an example of the core network CN of the communication system 1. FIG. 15 is a diagram illustrating the example of a 4G architecture. Note that the core network CN illustrated in FIG. 15 does not include the management function (congestion control manager (CCM)) for managing communication using a predetermined network slice (e.g., network slice for low latency), but the core network CN may include the CCM as one of the network functions. Naturally, the CCM may be a network function disposed outside the core network CN.

As illustrated in FIG. 15, the core network CN includes an eNB 20, a mobility management entity (MME) 452, a serving gateway (S-GW) 453, a packet data network gateway (P-GW) 454, and a home subscriber server (HSS) 455.

The eNB 20 functions as a 4G base station. An MME 452 is a control node that handles a control plane signal and manages a movement state of a UE 401. The UE 401 sends an attach request to the MME 452 to attach to the cellular system.

An S-GW 453 is a control node that handles the user plane signal, and is a gateway device that switches a transfer path of user data. A P-GW 454 is a control node that handles the user plane signal and is a gateway device serving as a connection point between the core network CN and the Internet. An HSS 455 is a control node that handles subscriber data and performs service control.

The MME 452 corresponds to functions of the AMF 441 and the SMF 442 in the 5G network. In addition, the HSS 455 corresponds to the function of the UDM 448.

As illustrated in FIG. 15, the eNB 20 is connected to the MME 452 via an S1-MME interface, and is connected to the S-GW 453 via an S1-U interface. The S-GW 453 is connected to the MME 452 via an S11 interface, and the MME 452 is connected to the HSS 455 via an S6a interface. The P-GW 454 is connected to the S-GW 453 via an S5/S8 interface.

### 4. First Embodiment

The configuration of the communication system 1 has been described above. Next, the operation of the communication system 1 having the above configuration will be described.

### <4-1. Problem>

Low-latency communication is extremely important in requirements for the private network. This is because there are many use cases that require the low-latency communication between the UE and the UE and between the AF and the UE. Even when QoS for achieving low latency is assigned to a service requiring low latency, the low latency cannot be achieved when a communication line is congested. Even when the scheduler of the base station performs priority control of a TCP/UDP packet based on the conventional QoS for the service requiring low latency, a similar result is obtained.

In order to solve this problem, it is conceived to prepare an individual user plane function (UPF) for a service that requires low latency in the core network, and assign an individual frequency resource to the UE that uses the UPF. This is a technique called network slicing. A network slice is a network isolated from other network slices. Therefore, it is considered that it is possible to provide the low-latency communication to a service using the network slice by preparing the network slice to be operated with a low load and operating the network slice so as not to cause congestion.

As described above, FIG. 7 is the diagram illustrating the experimental result of the delay property of each network slice. In the example in FIG. 7, different frequency resources and different UPF resources are allocated to the network slice 1 and the network slice 2, respectively. As can be seen in FIG. 7, even when the network slice 2 is congested, the delay property of the network slice 1 is good. In addition, it can be seen that a delay of about 30 ms (round-trip delay by ping) can be realized between App and UE. In addition, it can be seen that the delay property is deteriorated in congested network slice 2. In addition, the network slice 1 is isolated from the network slice 2, and it is apparent that congestion of the network slice 2 does not affect the network slice 1.

When there is one service using the network slice and there is only one TCP connection, the low latency is secured as in the left graph of FIG. 7. However, when there are a plurality of services using the network slice and there are a plurality of sessions of the TCP packet, or when there are a plurality of exchanges of the UDP packet corresponding to the service, it is assumed that the low latency cannot be secured due to an influence of congestion. In other words, in order to provide a low-latency service, the network slice is prepared, and then a system for maintaining a low load in the network slice is required.

As described above, FIG. 8 is the diagram illustrating the difference in the delay property of the network slice due to a difference in packet sizes. As can be seen in FIG. 8, even in the network slice 1 operating at a throughput of about 10 Mbps, there is a difference in the delay property between the packet sizes of 100 bytes and 1000 bytes. It can be seen that when the packet size is large, low latency of a service that requires low latency cannot be secured.

From the above, it can be seen that it is important to keep the packet size small in order to keep a low load for a network slice prepared for low latency How to keep the low latency for the network slice will be described in detail below.

### <4-2. Solution 1>

The network management device 40 of the private network A assigns an individual frequency resource and an individual UPF resource for a service that requires low latency. In the following description, this is referred to as a network slice for low latency.

In addition, the network management device 40 of the private network A has the management function (congestion control manager (CCM)) for managing communication using a predetermined network slice (e.g., network slice for low latency). The management function (hereinafter referred to as CCM) is responsible for permitting the use of the network slice for low latency from the AF in order to limit a traffic assigned to the network slice for low latency to low load and small packets. In the following description, it is assumed that the UPF1 is allocated as the UPF resource to the network slice for low latency. Note that the description of the “UPF1” in the following description can be appropriately replaced with the “network slice for low latency”.

During operation, a core network (e.g., management device 10) measures a load state of the UPF1. At this time, the core network performs both measurement related to the throughput and measurement related to the packet size. Then, the core network notifies the CCM of measurement results. Note that a measurement result regarding the packet size is, for example, an average packet size or a packet size distribution. The CCM acquires information on the load state of the UPF1 (a measurement result regarding the throughput and a measurement result regarding the packet size) from the core network. The load state of the UPF1 may be measured by CCM. In other words, the CCM may directly obtain load state information of the UPF1.

Thereafter, the CCM determines whether the load state of the UPF1 (network slice for low latency) is low based on the acquired load state information. At this time, the CCM may determine that the UPF1 has a low load when the measurement result of the throughput and the measurement result of the packet size satisfy a predetermined criteria.

When it is determined that the UPF1 has the low load, the CCM notifies the UPF1 or a node (UE/AF) using the UPF1 that the predetermined operation is permitted. For example, when it is determined that the UPF1 has the low load, the CCM notifies the UPF1 that a new node (e.g., new UE) is allowed to be allocated to the UPF1. In addition, when it is determined that the UPF1 has the low load, the CCM notifies a node using the UPF1 (network slice for low latency) of permission to generate the traffic using the UPF1 (network slice for low latency).

When the UPF1 is not determined to have the low load, the CCM does not allow the UPF1 or the node (UE/AF) using the UPF1 to perform the predetermined operation. For example, when it is not determined that the UPF1 has the low load, the CCM does not permit a new node (e.g., new UE) to be assigned to the UPF1. In addition, when it is not determined that the UPF1 has the low load, the CCM does not allow the node (UE/AF) using the UPF1 (network slice for low latency) to generate the traffic using the UPF1 (network slice for low latency). At this time, the CCM may notify the AF using the network slice for low latency and the AF considering the use of the network slice for low latency of the load state information.

The CCM (or core network) may measure the load state of the UPF at a regular cycle. As a method of measuring the load state of the UPF1 (e.g., method of monitoring a packet flowing in the network slice for low latency), two types of methods are assumed. One is a method of performing measurement at a regular cycle, and the other is a method of performing measurement only when determining whether to increase the traffic. Considering that the UPF can be used for other purposes such as adding the UPF when the packet increases, it is desirable to measure the load state of the UPF1 (packet monitoring) at a regular cycle.

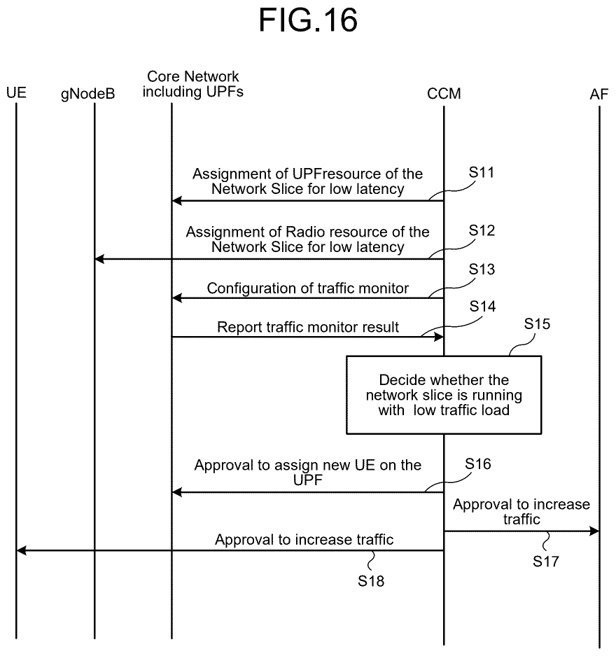

Hereinafter, a procedure of using the network slice for low latency will be described. FIG. 16 is a sequence diagram illustrating the procedure of using the network slice for low latency. In the following description, it is assumed that the node of the private network A (UE, gNodeB, core network, CCM, and AF) executes the following processes. The UE is, for example, the terminal device 30. The gNodeB is, for example, the base station 20. The core network is, for example, the management device 10. The CCM is, for example, the management function provided in the network management device 40 (or core network). The AF is an application function provided in the core network. In addition, it is assumed that the core network has a plurality of UPF resources. Hereinafter, the procedure of using the network slice for low latency will be described with reference to FIG. 16.

First, CCM notifies the core network that the UPF resource is assigned to the network slice for low latency (Step S11). The core network assigns a dedicated UPF resource to the network slice for low latency according to the notification. In the following description, the UPF assigned to the network slice for low latency is referred to as the UPF1. In addition, the CCM notifies the gNodeB that a dedicated radio resource is assigned to the network slice for low latency (Step S12). The gNodeB assigns the radio resource to the network slice for low latency according to the notification.

Next, the CCM notifies the core network to measure the load state of the network slice for low latency (Step S13). The core network measures the load state of the network slice for low latency. At this time, the core network measures the load state of the network slice for low latency by measuring the load state of the UPF1. Note that the core network measures the load state of the UPF1 separately for the uplink and the downlink. For example, the core network measures an average value of the throughput of each UL/DL and the packet size (packet length) of each UL/DL. Then, the core network notifies the CCM of the measurement result of the load state of the UPF1. The CCM acquires information on the measurement result of the load state of the UPF1 from the core network (Step S14).

The CCM determines whether the load state of the network slice for low latency (UPF1) is low based on the measurement result of the load state of the UPF1 (Step S15). At this time, CCM may determine that the load state of the network slice for low latency (UPF1) is low when the average value of the throughput of each UL/DL and the packet size (packet length) of each UL/DL satisfy the following determination criteria. At this time, the CCM determines that the load state of the network slice for low latency (UPF1) is low when all the following conditions (A1) to (A4) are satisfied.

### (Example of Determination Criteria)

(A1) UL throughput<Threshold 1 (e.g., 10 Mbps)
(A2) DL throughput<Threshold 2 (e.g., 10 Mbps)
(A3) UL packet size average<Threshold 3 (e.g., average of 150 bytes)
(A4) Average DL packet size<Threshold 4 (e.g., average of 150 bytes)

Note that the CCM may determine whether or not the load state of the network slice for low latency (UPF1) is low by using information on statistical distribution of packet sizes instead of the information on average packet size.

When it is determined that the network slice for low latency (UPF1) has the low load, the CCM notifies the core network of a permission to assign a new UE to the UPF1 (Step S16). The core network assigns the new UE that uses the low-load service to the UPF1. At this time, the core network may associate the new UE using the low-latency service with the UPF1 by rewriting a subscriber file. When the new UE attaches to the network, the new UE is assigned to the UPF1. Accordingly, packets transmitted and received by the new UE use the UPF1.

In addition, when it is determined that the network slice for low latency (UPF1) has the low load, the CCM may notify the node using the UPF1 of a permission to generate the traffic using the UPF1. For example, the CCM may notify the AF of a permission to generate the traffic (Step S17), or may notify the UE of the permission to generate the traffic (Step S18). As a result, the UE can transmit and receive a packet for low latency.

In the above solution, the CCM acquires the information regarding the throughput and the information regarding the packet size as the load state information of the network slice for low latency (UPF1). However, the CCM may acquire information on a delay time of a packet passing through the UPF1 as the load state information of the network slice for low latency (UPF1). Then, CCM may determine that the network slice for low latency (UPF1) has a low load when the delay time of the packet passing through the UPF1 satisfies a predetermined criteria.

In theory, the delay time of End to End (E2E) is to be measured. However, it is easy to measure passing time of the packet in the UPF1 in terms of implementation, and there is a great advantage in configuring the system. Actually, there is also a delay time at the base station, but the delay time at the UPF also increases as the base station becomes crowded. Therefore, the load state of the network slice for low latency (UPF1) can be estimated only by measuring the delay time of the packet passing through the UPF1 (passing time of the packet in the UPF1).

A method of measuring a process delay at the base station is also assumed. For example, the base station measures a delay time of a packet passing through the base station (passing time of the packet at the base station), and sends a measurement result to the CCM. The CCM may determine the load state of the network slice for low latency (UPF1) based on information on the delay time of the packet passing through the UPF1, information on the delay time of the packet passing through the base station, or both information.

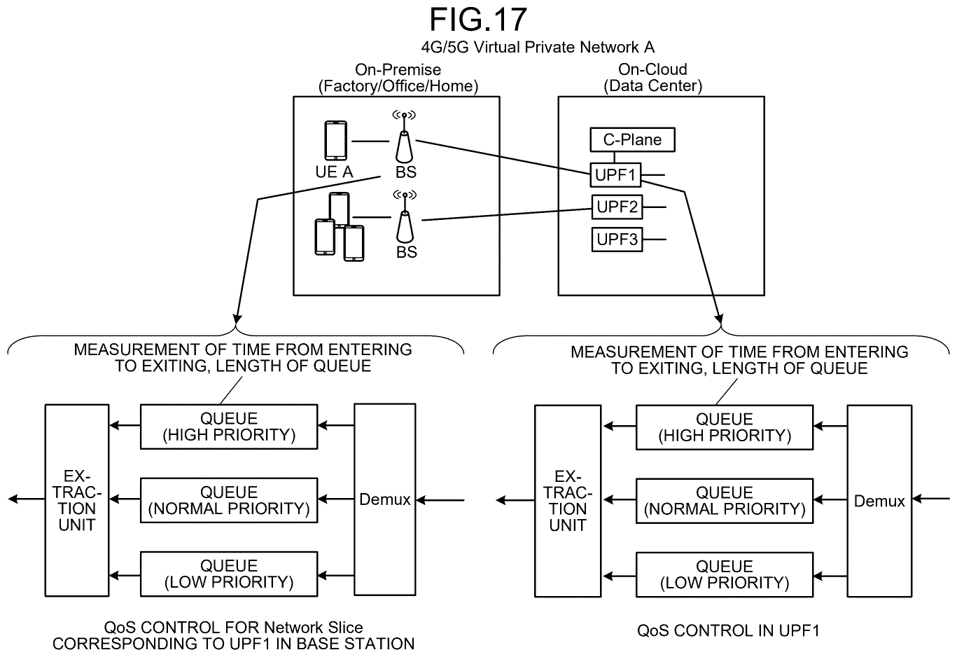

FIG. 17 is a diagram illustrating a method of measuring the delay time of the packet passing through the UPF1 or the base station. The CCM may acquire information on the passing time of a queue for QoS with the highest priority as the delay time of the packet passing through the UPF1 or the base station. In addition, the CCM may acquire information on a length of the queue or a length of packets accumulated in the queue instead of the passing time of the packet.

According to the present solution, since the information on the throughput and the packet size is used to evaluate the load state, the state of the network slice for low latency can be accurately maintained in the low load state. As a result, the low-latency communication can be provided.

### <4-3. Solution 2>

There is a case where a plurality of private networks is connected. In this case, although low UPF load can be guaranteed in one private network (hereinafter referred to as the private network A), the low-latency communication cannot be realized when low UPF load cannot be guaranteed in the other private network connected (hereinafter referred to as the private network B.).

Therefore, in Solution 2, the CCM acquires not only the load state information of the UPF1 of the private network A (hereinafter referred to as the first UPF1) but also the load state information of the UPF1 of the private network B (hereinafter also referred to as the second UPF1). Both the first UPF1 and the second UPF1 are UPF resources of the network slice for low latency. Then, when both the load state of the first UPF1 and the load state of the second UPF1 are low, the CCM approves addition of a node to the UPF1 or addition of new traffic.

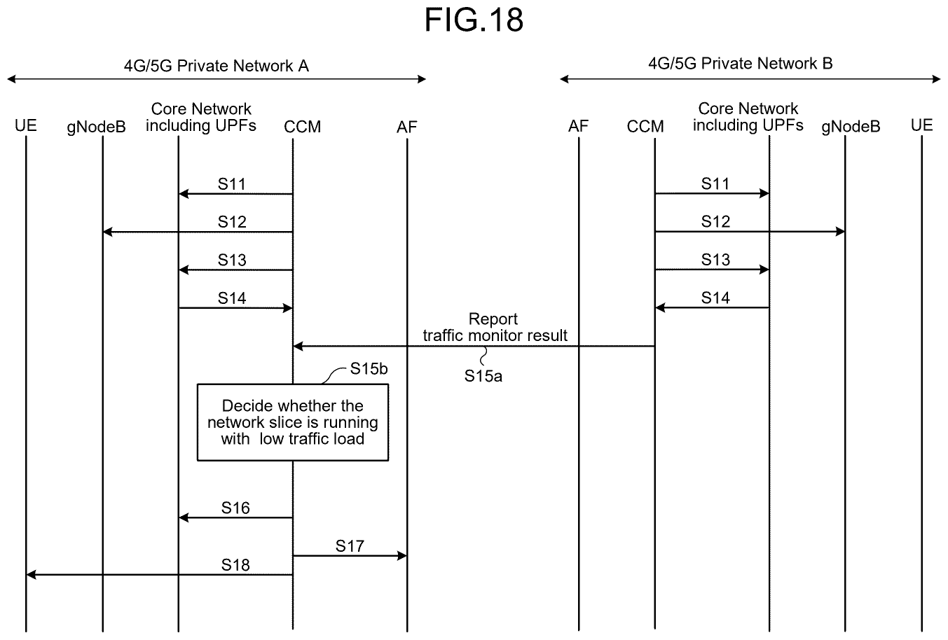

Hereinafter, a procedure of using the network slice for low latency when a plurality of private networks is connected will be described. FIG. 18 is a sequence diagram illustrating a procedure of using the network slice for low latency. In an example in FIG. 18, the private network A and the private network B are connected. Then, the node (UE or AF) of the private network A and the node (UE or AF) of the private network B communicate using the network slice for low latency.

In order to keep the low-latency communication between the UEs, both the network slice on the private network A side and the network slice on the private network B side need to be in the low load state. In Solution 1 of the first embodiment, the state in which the UPF is operated at a low load is maintained by observing one UPF. In Solution 2, the CCM measures both the UPF1 of the private network A (hereinafter first UPF1) and the UPF1 of the private network B (second UPF1) are measured to generate new traffic after confirming that each UPF has a low load.

In the following description, it is assumed that the node of the private network A (UE, gNodeB, core network, CCM, and AF) and the node of the private network B (UE, gNodeB, core network, CCM, and AF) perform the following process. The UE is, for example, the terminal device 30. The gNodeB is, for example, the base station 20. The core network is, for example, the management device 10. The CCM is, for example, the management function provided in the network management device 40 (or core network). The AF is an application function provided in the core network. In addition, it is assumed that each of the core network of the private network A and the core network of the private network B has a plurality of UPF resources. Hereinafter, a procedure of using the network slice for low latency will be described with reference to FIG. 18.

First, each of the CCM of the private network A and the CCM of the private network B notifies the core network that the UPF resource is assigned to the network slice for low latency (Step S11). Each of the core networks of the private networks A and B assigns a dedicated UPF resource to the network slice for low latency according to the notification. In the following description, the UPF assigned to the network slice for low latency is referred to as the UPF1 (first UPF1 or second UPF1). In addition, each of the CCMs of the private networks A and B notifies the gNodeB that a dedicated radio resource is to be assigned to the network slice for low latency (Step S12). Each of the gNodeBs of the private networks A and B assigns the radio resource to the network slice for low latency according to the notification.

Next, each of the CCMs of the private networks A and B notifies the core network to measure the load state of the network slice for low latency (Step S13). The core network measures the load state of the network slice for low latency. At this time, the core network measures the load state of the network slice for low latency by measuring the load state of the UPF1 (first UPF1 or second UPF1). Then, the core network of the private network A measures the load state of the first UPF1, and the core network of the private network B measures the load state of the second UPF1.

Then, the core networks of the private networks A and B notify the CCM of the measurement result of the load state of the UPF1 (first UPF1 or second UPF1). For example, the core network of the private network A notifies the CCM of the private network A of the load state information of the first UPF1, and the core network of the private network B notifies the CCM of the private network B of the load state information of the second UPF1. Each of the CCMs of the private networks A and B acquires information on the measurement result of the load state of the UPF1 (first UPF1 or second UPF1) from the core network (Step S14). Similarly to Solution 1, the information on the measurement result of the load state may be information on the throughput and information on the packet size.

Subsequently, the CCM of the private network B transmits information on the measurement result of the load state of the second UPF1 to the CCM of the private network A. The CCM of the private network A acquires information on the measurement result of the load state of the second UPF1 from the CCM of the private network B (Step S15a).

The CCM of the private network A determines whether the load state of the network slice for low latency (first UPF1 and second UPF) is low based on the measurement results of the load states of both the first UPF1 and the second UPF1 (Step S15b). At this time, the CCM of the private network A may determine that the load state of the network slice for low latency (UPF1) is low when an average value of the throughput of each UL/DL and the packet size (packet length) of each UL/DL satisfy the following determination criteria. At this time, the CCM determines that the load state of the network slice for low latency (UPF1) is low when all the following conditions (A1) to (A4) and (B1) to (B4) are satisfied.

### (Example of Determination Criteria for First UPF1)

(A1) UL throughput<Threshold 1 (e.g., 10 Mbps)
(A2) DL throughput<Threshold 2 (e.g., 10 Mbps)
(A3) Average UL packet size<Threshold 3 (e.g., average of 150 bytes)
(A4) Average DL packet size<Threshold 4 (e.g., average of 150 bytes)

### (Example of Determination Criteria for Second UPF1)

(B1) UL throughput<Threshold 1 (e.g., 10 Mbps)
(B2) DL throughput<Threshold 2 (e.g., 10 Mbps)
(B3) Average UL packet size<Threshold 3 (e.g., average of 150 bytes)
(B4) Average DL packet size<Threshold 4 (e.g., average of 150 bytes)

Note that the CCM may determine whether or not the load state of the network slice for low latency (first UPF1 and second UPF1) is low by using evaluation based on statistical values such as the maximum value and variance of the packet length instead of the information on the average packet size. This is because, when only the average packet size is used, it can be assumed that determination may not function well in a case where the maximum value and the minimum value greatly deviate from each other.

When it is determined that both the first UPF1 and the second UPF1 have the low load, the CCM of the private network A notifies the core network of a permission to assign a new UE to the first UPF1 (Step S16). The core network of the private network A assigns the new UE that uses a low-latency service to the first UPF1.

In addition, when both the first UPF1 and the second UPF1 are determined to have the low load, the CCM of the private network A may notify the node using the first UPF1 of a permission to generate the traffic using the first UPF1. For example, the CCM of the private network A may notify AF of the private network A of a permission to generate the traffic (Step S17), or may notify the UE of the private network A of the permission to generate the traffic (Step S18). As a result, the UE can transmit and receive a packet for low latency.

Note that the traffic increased on the private network A side directly flows into and out of the second UPF1 on the private network B side, but since it is confirmed in advance that the load is low, both UPF1 can maintain the low load state.

According to the present solution, it is possible to provide a low-latency environment even when UEs communicate each other using the plurality of private networks.

### 5. Second Embodiment

Next, an operation of a communication system 1 according to the second embodiment will be described.

### <5-1. Problem>

In certain use cases, such as operation of a remote surgical system or a remote robot, very accurate low-latency communication is required. However, when a conventional method using a network slice is used, a stochastic occurrence of a delay can be reduced, but a large delay occurs when packets happen to collide with each other frequently.

In particular, the current QoS control determines for which session an uplink or downlink radio resource is assigned in the scheduler of the base station. In an application layer, whether to permit traffic generation is 0/1 control. Therefore, in the conventional method, only stochastic adjustment that the load is low is performed, and low latency may not occur with a certain probability.

### <5-2. Solution 1>

In order to solve the above problem, in the second embodiment, scheduling at the application layer level is introduced in which a transmission/reception timing is adjusted in the application layer (service layer).

For example, it is assumed that a plurality of network slices (UPF) including a network slice for low latency (UPF1) are prepared in the private network A. The network slice is divided into the radio resource and the UPF resource, and the UE is designated which UPF to use when accessing the network. In the present embodiment, the CCM adjusts the transmission/reception timing between a plurality of services/applications using the network slice for low latency (UPF1). The service/application is, for example, a service/application installed in user equipment (UE) or an application function (AF).

An application level scheduler inside the CCM notifies an application of the UE or an application of the AF of a transmission timing. The application of the UE or the application of the AF transmits a packet to a transmission destination (UE or AF) at the instructed transmission timing. The instructed packet may be transmitted in the UL or in the DL. Here, the UL is a direction from the UE toward the base station, and the DL is a direction from the base station toward the UE. The packet is a packet (TCP/UDP, IP packet) used by the application layer in normal communication. The packet arrives at a target UE or AF through the network slice for low latency (UPF1).

Note that the UE or AF that has received the packet (also referred to as a trigger packet) often sends back a response packet to the packet. The application level scheduler immediately returns this response packet without timing adjustment. It is considered that adjustment of only the transmission timing of the trigger packet is sufficient by the application level scheduler. Here, the trigger packet is a packet that becomes a starting point of communication (packet that causes initiation). For example, the trigger packet is a first packet in transmission and reception of a set of packets, i.e., transmission of a packet and transmission of a response packet to the packet.

By scheduling at the application level, a delay of the packet transmitted by the application can be prevented. Since the transmission timing is deterministically determined, congestion does not occur much. Although it can be said that the application cannot output a packet at a desired timing, there is a great advantage in that the application knows that a low-latency response without congestion is guaranteed when the application outputs the packet at that timing. Since the remote control of the device only transmits the control packet at a regular cycle and receives its ACK from the device, there is no problem for the application side even with the application-level scheduler. Conventionally, even when the application side transmits a control packet at a regular cycle, time that the control packet arrives is not constant due to network congestion. This method can minimize a delay and keep a constant time for arrival of the control packet.

Methods for designating the packet transmission timing include a static/semi-static designation method and a dynamic designation method. The static/semi-static designation method is a method of periodically assigning a transmission timing at a predetermined timing. Hereinafter, the scheduling method of the present embodiment will be described separately for the static/semi-static method and the dynamic method.

### <5-2-1. Static/Semi-Static Scheduling Method>

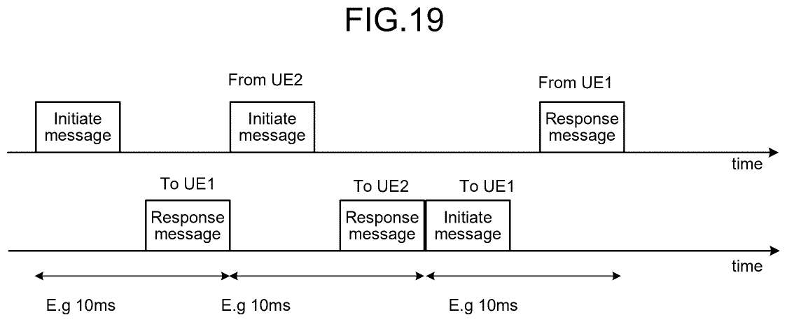

First, the static/semi-static scheduling method will be described. FIG. 19 is a diagram illustrating the static/semi-static scheduling method. In the static/semi-static scheduling method, for example, the CCM designates a duration in which a packet can be transmitted and a period thereof to the node (UE or AF) using the network slice for low latency (UPF1). When the static/semi-static scheduling method is used, it is necessary to perform time synchronization in advance between nodes where communication is performed.

In an example in FIG. 19, communication is performed between the UE 1 and the UE 2. One UE sends an initiation message to the other UE, and the other UE returns a response message to the one UE in response to the initiation message. The initiation message is the trigger packet, and the response message is the response packet. In the example in FIG. 19, a delay of a radio part is assumed to be about 1 ms to 5 ms. Therefore, it is considered that the transmission/reception operation can be performed with a frame configuration of a 10-ms cycle. In the case of 4G LTE in which the delay of the radio part increases, frames may be configured at a cycle of 30 ms to 100 ms.

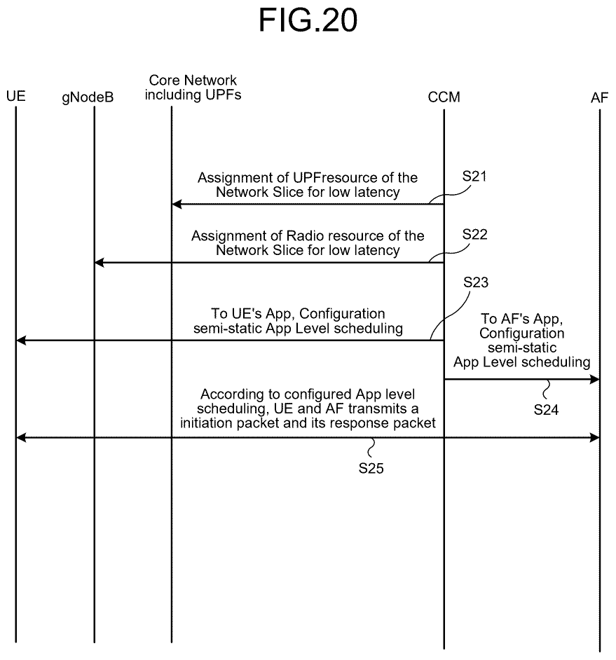

Hereinafter, a procedure of a semi-static application level scheduling will be described. FIG. 20 is a sequence diagram illustrating a procedure of the semi-static application level scheduling. In the following description, it is assumed that the node of the private network A (UE, gNodeB, core network, CCM, and AF) executes the following processes. The UE is, for example, the terminal device 30. The gNodeB is, for example, the base station 20. The core network is, for example, the management device 10. The CCM is, for example, the management function provided in the network management device 40 (or core network). The AF is an application function provided in the core network. In addition, it is assumed that the core network has a plurality of UPF resources. Hereinafter, the procedure of the semi-static application level scheduling will be described with reference to FIG. 20.

First, the CCM notifies the core network that the UPF resource is assigned to the network slice for low latency (Step S21). The core network assigns a dedicated UPF resource to the network slice for low latency according to the notification. In the following description, the UPF assigned to the network slice for low latency is referred to as the UPF1. In addition, the CCM notifies the gNodeB that a dedicated radio resource is assigned to the network slice for low latency (Step S22). The gNodeB assigns the radio resource to the network slice for low latency according to the notification.

Next, the CCM notifies the node (e.g., UE or AF) using the network slice for low latency (UPF1) to control traffic generation at the application level. For example, the CCM notifies the node using the network slice for low latency (UPF1) to control transmission of a trigger packet of the node. More specifically, the CCM notifies the node that uses the network slice for low latency (UPF1) of application-level schedule information related to the transmission of the trigger packet. The schedule information is, for example, information for designating the transmission timing of the trigger packet at the application level.

In an example in FIG. 20, the CCM notifies the UE using the network slice for low latency (UPF1) of the schedule information related to the transmission of the trigger packet (Step S23). In addition, the CCM notifies the AF using the network slice for low latency (UPF1) of the schedule information related to transmission of the trigger packet (Step S24). The UE and the AF transmit and receive packets according to the schedule information (Step S25).

### <5-2-2. Dynamic Scheduling Method>

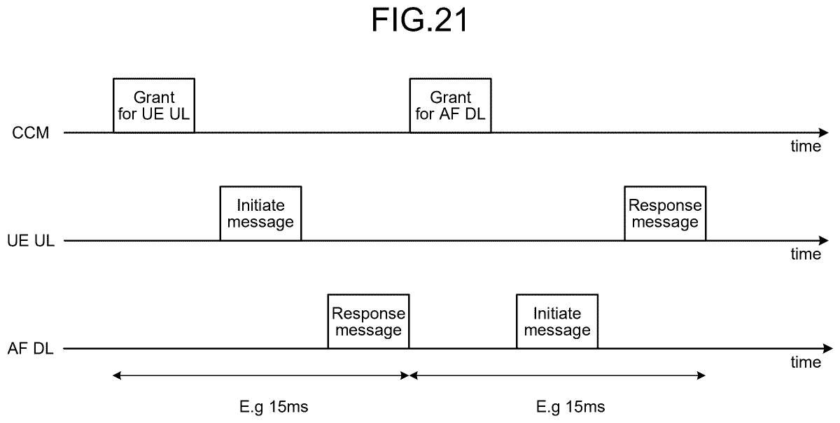

Next, the dynamic scheduling method will be described. FIG. 21 is a diagram illustrating the dynamic scheduling method. In the dynamic scheduling method, for example, the CCM transmits a timing packet (hereinafter referred to as a grant packet) to the node (UE or AF) using the network slice for low latency (UPF1). The grant packet is, for example, a packet for permitting the node that performs communication using the network slice for low latency (UPF1) to transmit the trigger packet. The node using the network slice for low latency (UPF1) can only transmit a packet when the grant packet is received.

In an example in FIG. 21, communication is performed between the UE 1 and the UE 2. In the example in FIG. 21, the CCM notifies one UE of the UE 1 and UE 2 of a permission to transmit the trigger packet (transmission of the grant packet) at a timing at which the transmission of the trigger packet is permitted. One UE transmits an initiation message to the other UE at the timing of receiving the grant packet. Then, in response to the message, the other UE returns a response message to the one UE. The initiation message is the trigger packet, and the response message is the response packet. In the example in FIG. 21, it is considered that the transmission/reception operation can be performed at a cycle of 15 ms.

While static/semi-static scheduling method relies on time synchronization, the dynamic scheduling method can operate without accurate time synchronization. This is because the grant packet plays a role of forming a frame. In addition, the static/semi-static scheduling method does not require the grant packet and has less resource overhead, so that a cycle can be shortened as compared with the dynamic method. However, unlike the dynamic scheduling method, the static/semi-static scheduling method cannot flexibly perform communication between the nodes according to the state of a communication path. In this respect, the dynamic scheduling method is more advantageous than the static/semi-static scheduling method.

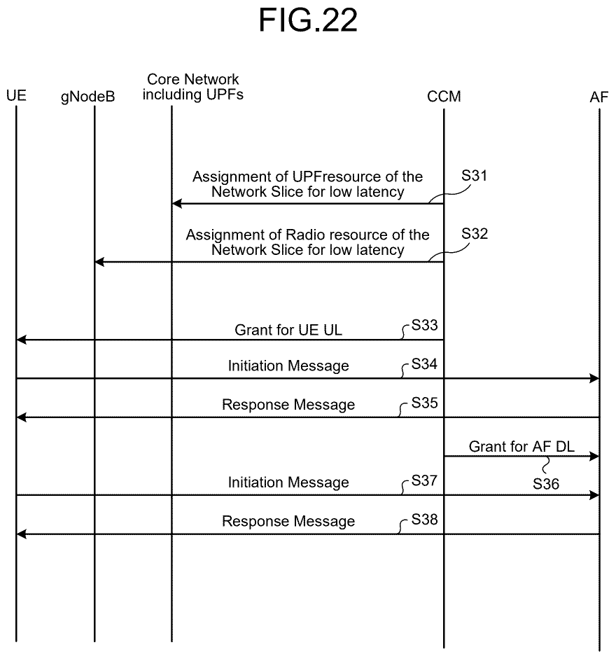

Hereinafter, a procedure of the dynamic application level scheduling will be described. FIG. 22 is a sequence diagram illustrating the procedure of the dynamic application level scheduling. In the following description, it is assumed that the node of the private network A (UE, gNodeB, core network, CCM, and AF) executes the following processes. The UE is, for example, the terminal device 30. The gNodeB is, for example, the base station 20. The core network is, for example, the management device 10. The CCM is, for example, the management function provided in the network management device 40 (or core network). The AF is an application function provided in the core network. In addition, it is assumed that the core network has a plurality of UPF resources. Hereinafter, the procedure of dynamic application level scheduling will be described with reference to FIG. 22.

First, the CCM notifies the core network that the UPF resource is assigned to the network slice for low latency (Step S31). The core network assigns a dedicated UPF resource to the network slice for low latency according to the notification. In the following description, the UPF assigned to the network slice for low latency is referred to as the UPF1. In addition, the CCM notifies the gNodeB that a dedicated radio resource is assigned to the network slice for low latency (Step S32). The gNodeB assigns the radio resource to the network slice for low latency according to the notification.

Next, the CCM notifies the node (e.g., UE or AF) using the network slice for low latency (UPF1) to control traffic generation at the application level. For example, the CCM notifies the node using the network slice for low latency (UPF1) to control transmission of a trigger packet of the node. More specifically, the CCM notifies the node using the network slice for low latency (UPF1) of a permission to transmit the trigger packet (transmission of the grant packet) at a timing of permitting transmission of the trigger packet.

For example, the CCM transmits a grant packet for permitting uplink communication to the UE using the network slice for low latency (UPF1) (Step S33). The UE transmits an initiation message to the AF at the timing of receiving the grant packet (Step S34). Then, the AF returns a response message to the UE in response to the message (Step S35). The initiation message is the trigger packet, and the response message is the response packet.

Thereafter, the CCM notifies the AF using the network slice for low latency (UPF1) of transmission of the grant packet for permitting downlink communication (Step S36). The AF transmits the initiation message to the UE at the timing when the grant packet is received (Step S37). Then, the UE returns the response message to the AF in response to the message (Step S38).

According to the present solution, a deterministic low latency (i.e., low latency with extremely high accuracy) can be realized.

### <5-3. Solution 2>

There is a case where a plurality of private networks is connected. In this case, even when the transmission timing of the application level is adjusted in one private network (hereinafter referred to as the private network A), a low-latency communication cannot be guaranteed unless the transmission timing of the application level is adjusted in the other private network connected (hereinafter referred to as the private network B).

For example, it is assumed that communication is performed between a UE group belonging to the UPF1 of the private network A (hereinafter, first UPF1) and a UE group belonging to the UPF1 of the private network B (hereinafter, second UPF1). At this time, even when the transmission timing is adjusted only inside the private network A, simultaneous transmission of the packet occurs in some cases and low latency cannot be guaranteed when the UE of the private network B transmits the packet to the UE of the private network A at an arbitrary timing.

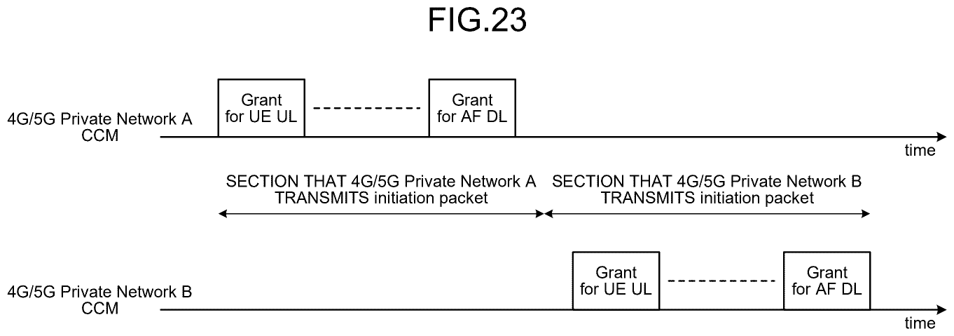

FIG. 23 is a conceptual diagram of a time direction of dynamic scheduling in the plurality of private networks. For example, it is assumed that communication is performed between the UE belonging to the first UPF1 and the UE belonging to the second UPF1. In this case, when the UE belonging to the first UPF1 triggers communication to start, the application level scheduler of the CCM of the private network A performs transmission timing adjustment of the UE belonging to the first UPF1. When the UE belonging to the second UPF1 triggers communication to start, the application level scheduler of the CCM of the private network B performs transmission timing adjustment of the UE belonging to the second UPF1. For transmission of the response packet after receiving the packet, neither application level scheduler indicates the transmission timing. Upon receiving the trigger packet (Initiation message), the UE immediately returns the response packet.

When the packet from the private network A and the packet from the private network B are transmitted at the same time, low latency cannot be guaranteed. Therefore, time adjustment of the application level schedule is required between the CCM of the private network A and the CCM of the private network B. This adjustment may be determined by mutual negotiation, or a central management device may assign a scheduling slot to each of the private networks.

In the method described in the present solution, each of the private network A and the private network B has a scheduling function. This is because each network may operate individually. Since the two networks are connected when necessary, the schedulers may adjust the timings of the transmission packets so as not to overlap each other at that time. Coordinated scheduling assignment of both may be performed from an upper network in a top-down manner.

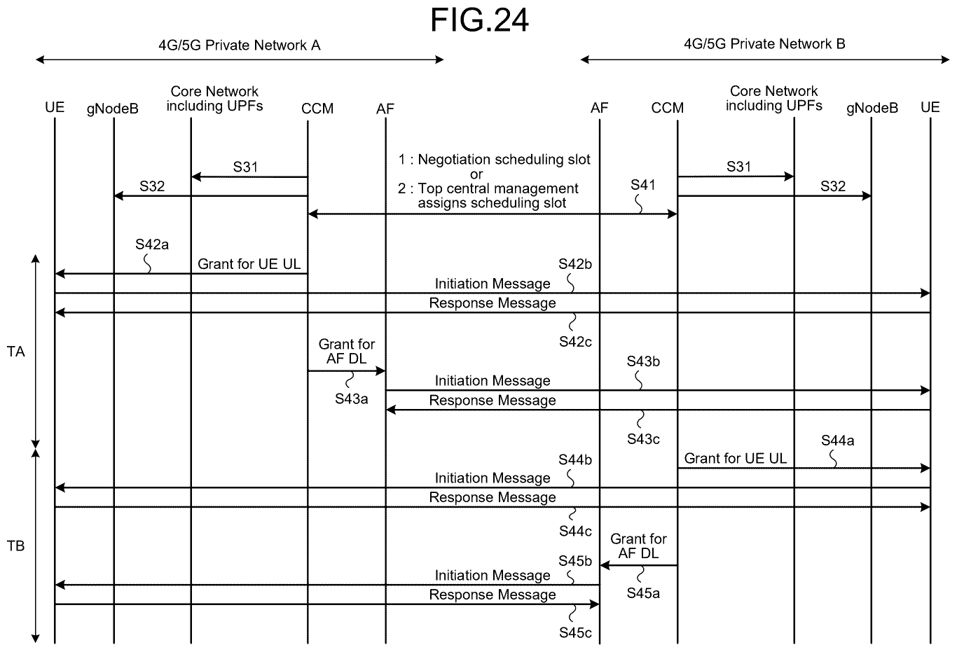

Hereinafter, a procedure of dynamic application level scheduling when the plurality of private networks is connected will be described. FIG. 24 is a sequence diagram illustrating the procedure of the dynamic application level scheduling. In an example in FIG. 24, the private network A and the private network B are connected. Then, the node (UE or AF) of the private network A and the node (UE or AF) of the private network B communicate using the network slice for low latency. In FIG. 24, TA is a section in which the node of the private network A transmits the trigger packet (initiation message), and TB is a section in which the node of the private network B transmits the trigger packet (Initiation message).

In the following description, it is assumed that the node (UE, gNodeB, Core Network, CCM, and AF) of the private network A and the node (UE, gNodeB, Core Network, CCM, and AF) of the private network B perform the following processes. The UE is, for example, the terminal device 30. The gNodeB is, for example, the base station 20. The core network is, for example, the management device 10. The CCM is, for example, the management function provided in the network management device 40 (or core network). The AF is an application function provided in the core network. In addition, it is assumed that each of the core network of the private network A and the core network of the private network B has a plurality of UPF resources. Hereinafter, a procedure of dynamic application level scheduling will be described with reference to FIG. 24.

First, the CCM of the private network A and the CCM of the private network B notify the core network that the UPF resource is assigned to the network slice for low latency (Step S31). Each of the core networks of the private networks A and B assigns a dedicated UPF resource to the network slice for low latency according to the notification. In the following description, the UPF assigned to the network slice for low latency is referred to as the UPF1 (first UPF1 or second UPF1). In addition, each of the CCMs of the private networks A and B notifies the gNodeB that a dedicated radio resource is to be assigned to the network slice for low latency (Step S32). Each of the gNodeBs of the private networks A and B assigns the radio resource to the network slice for low latency according to the notification.

The CCM of the private network A and the private network BCCM adjust traffic generation at an application level (Step S41). For example, the CCM of the private network A obtains, from the CCM of the private network B, information on control of traffic generation at the application level in the node (UE or AF) that uses the second UPF1. This information may be information on a timing at which the node using the second UPF1 generates traffic. In addition, the CCM of the private network B acquires, from the CCM of the private network A, information on control of traffic generation at the application level in the node (UE or AF) using the first UPF1. This information may be information on a timing at which the node using the second UPF1 generates traffic.

The CCM of the private network A notifies the node using the network slice for low latency (first UPF1) for controlling traffic generation at the application level in the node based on information acquired from the CCM of the private network B. In the example in FIG. 24, the CCM of the private network A transmits the grant packet to the UE using the first UPF1 (Step S42a). The UE transmits the initiation message to the UE that uses the network slice for low latency (second UPF1) of the private network B at the timing of receiving the grant packet (Step S42b). The UE that has received the initiation message returns the response message to the UE of the private network A (Step S42c).

Thereafter, the CCM of the private network A transmits the grant packet to the AF using the network slice for low latency (Step S43a). The AF transmits the initiation message to the UE using the network slice for low latency (second UPF1) of the private network B at the timing when the grant packet is received (Step S43b). The UE that received the initiation message returns the response message to the AF of the private network A (Step S43c).

In addition, the CCM of the private network A notifies the node using the network slice for low latency (second UPF1) to control traffic generation at the application level in the node based on information acquired from the CCM of the private network A. In the example in FIG. 24, the CCM of the private network B transmits the grant packet to the UE using the second UPF1 (Step S44a). The UE transmits the initiation message to the UE that uses the network slice for low latency (second UPF1) of the private network A at the timing of receiving the grant packet (Step S44b). The UE that received the initiation message returns the response message to the UE of the private network A (Step S44c).

Thereafter, the CCM of the private network B transmits the grant packet to the AF using the network slice for low latency (Step S45a). The AF transmits the initiation message to the UE using the network slice for low latency (first UPF1) of the private network A at the timing when the grant packet is received (Step S45b). The UE that received the initiation message returns the response message to the AF of the private network B (Step S45c).

According to the present solution, a deterministic low latency (e.g., low latency with extremely high accuracy) can be realized even in communication performed by connecting the plurality of private networks.

### 6. Modification

The above-described embodiments are examples, and various modifications and applications are possible.

For example, in the above-described embodiments, the plurality of 4G/5G private networks connected by the VPN tunnel is exemplified as the “plurality of non-public cellular closed networks connected by secure communication”. However, the “plurality of non-public cellular closed networks connected by secure communication” is not limited thereto, and may be, for example, “a plurality of 4G/5G private networks configured to perform cryptographic communication”.

A control device that controls the management device 10, the base station 20, the terminal device 30, and the network management device 40 of the present embodiments may be realized by a dedicated computer system or a general-purpose computer system.

For example, a communication program for executing the above-described operation is stored and distributed in a computer-readable recording medium such as an optical disk, a semiconductor memory, a magnetic tape, or a flexible disk. Then, for example, the program is installed on a computer, and the above-described processes are executed to configure the control device. Here, the control device may be a device (e.g., personal computer) outside the management device 10, the base station 20, and the terminal device 30. Furthermore, the control device may be a device inside the management device 10, the base station 20, the terminal device 30, and the network management device 40 (e.g., the control unit 13, the control unit 23, the control unit 33, and the control unit 43).

In addition, the above communication program may be stored in a disk device included in a server device on a network such as the Internet so that the communication program can be downloaded to the computer. In addition, the above-described functions may be realized by cooperation of an operating system (OS) and application software. In this case, a portion other than the OS may be stored in a medium and distributed, or a portion other than the OS may be stored in a server device and downloaded to the computer.

Among the processes described in the above embodiments, all or part of the processes described as being performed automatically can be performed manually, or all or part of the processes described as being performed manually can be performed automatically by a known method. In addition, the processing procedure, specific name, and information including various data and parameters illustrated in the above document and the drawings can be arbitrarily changed unless otherwise specified. For example, various types of information illustrated in each drawing are not limited to the illustrated information.

In addition, each component of each device illustrated in the drawings is functionally conceptual, and is not necessarily physically configured as illustrated in the drawings. In other words, a specific form of distribution and integration of each device is not limited to the illustrated form, and all or a part thereof can be functionally or physically distributed and integrated in an arbitrary unit according to various loads, usage conditions, and the like. Note that this configuration by distribution and integration may be performed dynamically.

In addition, the above-described embodiments can be appropriately combined in a region in which the processing content do not contradict each other. Furthermore, the order of each step illustrated in the flowchart of the above-described embodiments can be appropriately changed.

Furthermore, for example, the present embodiment can be implemented as any configuration constituting an apparatus or a system, for example, a processor as a system large scale integration (LSI) or the like, a module using a plurality of processors or the like, a unit using a plurality of modules or the like, a set obtained by further adding other functions to a unit, or the like (i.e., configuration of a part of device).

Note that, in the present embodiment, the system means a set of a plurality of components (devices, modules (parts), etc.), and it does not matter whether or not all the components are in the same housing. Therefore, the plurality of devices housed in separate housings and connected via the network and one device in which a plurality of modules is housed in one housing are both systems.

Furthermore, for example, the present embodiments can adopt a configuration of cloud computing in which one function is shared and processed by a plurality of devices in cooperation via a network.

### 7. Conclusion

As described above, the information processing apparatus (e.g., network management device 40) of the present embodiment includes the management function (CCM) that manages communication using the network slice for low latency of the private network A. The CCM notifies the management device 10 that manages the UPF1, that is a user plane function (UPF) resource of the network slice for low latency, or a node (e.g., UE or AF) that uses the UPF1 of a low-latency guarantee.

For example, the CCM of the private network A acquires information on the load state of the UPF1, and when the UPF1 is determined to have a low load, the CCM notifies the management device 10 that manages the UPF1 or the node that uses the UPF1 of a permission of a predetermined operation. For example, when it is determined that the UPF1 has a low load, the management function notifies the management device 10 that manages the UPF1 of a permission to assign a new node (e.g., UE). In addition, when it is determined that the UPF1 has a low load, the CCM notifies the node using the UPF1 of a permission to generate traffic using the UPF1. At this time, the CCM acquires the measurement result regarding the throughput and the measurement result regarding the packet size as the load state information of the UPF1, and determines that the UPF1 has a low load when the measurement result regarding the throughput and the measurement result regarding the packet size satisfy the predetermined criteria. The measurement result related to the packet size may be an average packet size or a distribution of packet sizes. Since the information on the throughput of the UPF1 and the packet size of the traffic is used to evaluate the load state, the state of the network slice 1 can be accurately maintained in the low load state. As a result, the low-latency communication can be provided.

Further, the private network A may be connected to the private network B. At this time, the CCM of the private network A acquires the load state information of the UPF1 (hereinafter also referred to as the first UPF1) of the private network A, and acquires the load state information of the UPF1 (hereinafter also referred to as the second UPF1) of the private network B from the CCM of the private network B. When it is determined that both the first UPF1 and the second UPF1 have a low load, the CCM of the private network A notifies the first UPF1 or the node using the first UPF1 of a permission of the predetermined operation (e.g., assignment of a new node to the first UPF1). As a result, even when the plurality of private networks is connected, it is possible to provide the low-latency communication.

In addition, the CCM of the private network A may notify the node using the UPF1 to control traffic generation at the application level in the node. When the private network A and the private network B are connected, the CCM of the private network A may obtain, from the CCM of the private network B, information on control of traffic generation at the application level in the node with respect to the node using the second UPF1. As a result, packet generation is controlled at the application level, so that overlapping of packet transmission/reception timings can be prevented. As a result, low latency can be guaranteed deterministically (e.g., guarantee of low latency with extremely high accuracy).

Although the embodiments of the present disclosure have been described above, the technical scope of the present disclosure is not limited to the above-described embodiments as it is, and various modifications can be made without departing from the gist of the present disclosure. In addition, the components of different embodiments and modifications may be appropriately combined.

Note that the effects of each embodiment described in the present specification are merely examples and not limited thereto, and other effects may be provided.

The present technology can also have the following configurations.

(1)

An information processing method executed by an information processing apparatus configured to manage communication using a predetermined network slice of a non-public cellular closed network, the method comprising:
giving a notification regarding a guarantee of low latency to a device that manages a first user plane function (UPF) or a node that uses the first UPF, the first UPF being a UPF resource of the predetermined network slice.
   (2)

The information processing method according to (1), comprising:
acquiring information on a load state of the first UPF, wherein
when the first UPF is determined to have a low load, a notification for permitting a predetermined operation is given to the device that manages the first UPF or the node that uses the first UPF.
   (3)

The information processing method according to (2), wherein
when the first UPF is determined to have the low load, a notification for permitting assignment of a new node to the first UPF is given to the device that manages the first UPF.
   (4)

The information processing method according to (2) or (3), wherein
when the first UPF is determined to have the low load, a notification for permitting generation of a traffic using the first UPF is given to the node that uses the first UPF.
   (5)

The information processing method according to any one of (2) to (4), wherein
as the information on the load state of the first UPF, a throughput measurement result and a packet size measurement result are acquired, and
the first UPF is determined to have the low load when the throughput measurement result and the packet size measurement result satisfy predetermined criteria.
   (6)

The information processing method according to (5), wherein
the packet size measurement result is an average packet size or a packet size distribution.
   (7)

The information processing method according to any one of (2) to (4), wherein
as the information on the load state of the first UPF, information on a delay time of a packet passing through the first UPF is acquired, and
the first UPF is determined to have the low load when the delay time of the packet passing through the first UPF satisfies predetermined criteria.
   (8)

The information processing method according to (7), wherein
as the delay time of the packet passing through the first UPF, information on a passing time of a queue for a quality of service (QOS) with a highest priority is acquired.
   (9)

The information processing method according to any one of (2) to (8), wherein
the load state of the first UPF is measured at a regular cycle.
   (10)

The information processing method according to (1), comprising:
acquiring information on a load state of the first UPF; and
acquiring, from another non-public cellular closed network connected to the non-public cellular closed network, information on a load state of a second UPF, the second UPF being a UPF resource of a predetermined network slice of the other non-public cellular closed network, wherein
when both the first UPF and the second UPF are determined to have a low load, a notification for permitting a predetermined operation is given to the first UPF or the node that uses the first UPF.
   (11)

The information processing method according to (1), wherein
a notification for controlling generation of a traffic at an application level in the node is given to the node that uses the first UPF.
   (12)

The information processing method according to (11), wherein
a notification for controlling transmission of a trigger packet of the node is given to the node that uses the first UPF.
   (13)

The information processing method according to (12), wherein
a notification regarding schedule information on the transmission of the trigger packet is given to the node that uses the first UPF.
   (14)

The information processing method according to (12), wherein
a notification for permitting the transmission of the trigger packet is given to the node that uses the first UPF at a timing of permitting the transmission of the trigger packet.
   (15)

The information processing method according to (1), comprising:
acquiring, from another non-public cellular closed network connected to the non-public cellular closed network, information regarding control of generation of a traffic at an application level in a node, the node using a second UPF, the second UPF being a UPF resource of a predetermined network slice of the other non-public cellular closed network, wherein
a notification for controlling the generation of the traffic at the application level in the node is given to the node that uses the first UPF based on the information acquired from the other non-public cellular closed network.
   (16)

The information processing method according to (1), wherein
the non-public cellular closed network is a 4G or 5G private network.
   (17)

The information processing method according to any one of (1) to (16), wherein
the node is user equipment (UE) or an application function (AF).
   (18)

The information processing method according to any one of (1) to (17), wherein
the predetermined network slice is a network slice for low latency.
   (19)

An information processing apparatus comprising a management function configured to manage communication using a predetermined network slice of a non-public cellular closed network, wherein
the management function gives a notification regarding a guarantee of low latency to a device that manages a first user plane function (UPF) or a node that uses the first UPF, the first UPF being a UPF resource of the predetermined network slice.
   (20)

An information processing system comprising:
a first information processing apparatus including a first management function configured to manage communication using a predetermined network slice of a first non-public cellular closed network; and
a second information processing apparatus including a second management function configured to manage communication using a predetermined network slice of a second non-public cellular closed network connected to the first non-public cellular closed network, wherein
the first non-public cellular closed network includes a first user plane function (UPF) that is a UPF resource of the predetermined network slice of the first non-public cellular closed network,
the second non-public cellular closed network includes a second UPF that is a UPF resource of the predetermined network slice of the second non-public cellular closed network, and
the first management function acquires, from the second management function, information regarding the second UPF or information regarding a node using the second UPF, and gives a notification regarding a guarantee of low latency to a device that manages the first UPF or a node that uses the first UPF based on the information from the second management function.

### REFERENCE SIGNS LIST

1 COMMUNICATION SYSTEM
10 MANAGEMENT DEVICE
20 BASE STATION
30 TERMINAL DEVICE
40 NETWORK MANAGEMENT DEVICE
11, 41 COMMUNICATION UNIT
21, 31 WIRELESS COMMUNICATION UNIT
12, 22, 32, 42 STORAGE UNIT
13, 23, 33, 43 CONTROL UNIT
211, 311 TRANSMISSION PROCESSING UNIT
212, 312 RECEPTION PROCESSING UNIT
213, 313 ANTENNA

1. An information processing method executed by an information processing apparatus configured to manage communication using a predetermined network slice of a non-public cellular closed network, the method comprising:
giving a notification regarding a guarantee of low latency to a device that manages a first user plane function (UPF) or a node that uses the first UPF, the first UPF being a UPF resource of the predetermined network slice.

2. The information processing method according to claim 1, comprising:
acquiring information on a load state of the first UPF, wherein
when the first UPF is determined to have a low load, a notification for permitting a predetermined operation is given to the device that manages the first UPF or the node that uses the first UPF.

3. The information processing method according to claim 2, wherein
when the first UPF is determined to have the low load, a notification for permitting assignment of a new node to the first UPF is given to the device that manages the first UPF.

4. The information processing method according to claim 2, wherein
when the first UPF is determined to have the low load, a notification for permitting generation of a traffic using the first UPF is given to the node that uses the first UPF.

5. The information processing method according to claim 2, wherein
as the information on the load state of the first UPF, a throughput measurement result and a packet size measurement result are acquired, and
the first UPF is determined to have the low load when the throughput measurement result and the packet size measurement result satisfy predetermined criteria.

6. The information processing method according to claim 5, wherein
the packet size measurement result is an average packet size or a packet size distribution.

7. The information processing method according to claim 2, wherein
as the information on the load state of the first UPF, information on a delay time of a packet passing through the first UPF is acquired, and
the first UPF is determined to have the low load when the delay time of the packet passing through the first UPF satisfies predetermined criteria.

8. The information processing method according to claim 7, wherein
as the delay time of the packet passing through the first UPF, information on a passing time of a queue for a quality of service (QoS) with a highest priority is acquired.

9. The information processing method according to claim 2, wherein
the load state of the first UPF is measured at a regular cycle.

10. The information processing method according to claim 1, comprising:
acquiring information on a load state of the first UPF; and
acquiring, from another non-public cellular closed network connected to the non-public cellular closed network, information on a load state of a second UPF, the second UPF being a UPF resource of a predetermined network slice of the other non-public cellular closed network, wherein
when both the first UPF and the second UPF are determined to have a low load, a notification for permitting a predetermined operation is given to the first UPF or the node that uses the first UPF.

11. The information processing method according to claim 1, wherein
a notification for controlling generation of a traffic at an application level in the node is given to the node that uses the first UPF.

12. The information processing method according to claim 11, wherein
a notification for controlling transmission of a trigger packet of the node is given to the node that uses the first UPF.

13. The information processing method according to claim 12, wherein
a notification regarding schedule information on the transmission of the trigger packet is given to the node that uses the first UPF.

14. The information processing method according to claim 12, wherein
a notification for permitting the transmission of the trigger packet is given to the node that uses the first UPF at a timing of permitting the transmission of the trigger packet.

15. The information processing method according to claim 1, comprising:
acquiring, from another non-public cellular closed network connected to the non-public cellular closed network, information regarding control of generation of a traffic at an application level in a node, the node using a second UPF, the second UPF being a UPF resource of a predetermined network slice of the other non-public cellular closed network, wherein
a notification for controlling the generation of the traffic at the application level in the node is given to the node that uses the first UPF based on the information acquired from the other non-public cellular closed network.

16. The information processing method according to claim 1, wherein
the non-public cellular closed network is a 4G or 5G private network.

17. The information processing method according to claim 1, wherein
the node is user equipment (UE) or an application function (AF).

18. The information processing method according to claim 1, wherein
the predetermined network slice is a network slice for low latency.

19. An information processing apparatus comprising a management function configured to manage communication using a predetermined network slice of a non-public cellular closed network, wherein
the management function gives a notification regarding a guarantee of low latency to a device that manages a first user plane function (UPF) or a node that uses the first UPF, the first UPF being a UPF resource of the predetermined network slice.

20. An information processing system comprising:
a first information processing apparatus including a first management function configured to manage communication using a predetermined network slice of a first non-public cellular closed network; and
a second information processing apparatus including a second management function configured to manage communication using a predetermined network slice of a second non-public cellular closed network connected to the first non-public cellular closed network, wherein
the first non-public cellular closed network includes a first user plane function (UPF) that is a UPF resource of the predetermined network slice of the first non-public cellular closed network,
the second non-public cellular closed network includes a second UPF that is a UPF resource of the predetermined network slice of the second non-public cellular closed network, and
the first management function acquires, from the second management function, information regarding the second UPF or information regarding a node using the second UPF, and gives a notification regarding a guarantee of low latency to a device that manages the first UPF or a node that uses the first UPF based on the information from the second management function.
